(19) United States
(12) Patent Application Publication
(10) Pub. No.: US 2017/0250869 A1
(43) Pub. Date: Aug. 31, 2017

(54) Managing network forwarding configurations using algorithmic policies

(71) Applicant: Andreas Richard Voellmy, Mountain View, CA (US)

(72) Inventor: Andreas Richard Voellmy, Mountain View, CA (US)

(21) Appl. No.: 15/530,855

(22) PCT Filed: Sep. 10, 2015
(86) PCT No.: PCT/EP2015/070714

§ 371 Date: Mar. 8, 2017

Related U.S. Application Data
(60) Provisional application No. 62/071,046, filed on Sep. 12, 2014.

(51) Int. Cl. H04L 12/24; H04L 12/26

(52) U.S. Cl. CPC H04L 41/0893; H04L 43/14; H04L 45/566

(57) ABSTRACT

Techniques for managing forwarding configurations in a data communications network include accessing, at the at least one controller, an algorithmic policy defined by a user comprising one or more programs written in a general-purpose programming language other than a language of data forwarding element forwarding rules, which algorithmic policy in particular defines a packet-processing function specifying how data packets are to be processed through the data communications network via the at least one controller. A forwarding configuration for at least one data forwarding element in the data communications network may be derived from the user-defined packet-processing policy, and may be applied to the at least one data forwarding element.

### BACKGROUND

A recent development in computer networking is the notion of Software-Defined Networks (“SDN” s), whereby a network is allowed to customize its behaviors through centralized policies at a conceptually centralized network controller. In particular, OpenFlow (introduced in N. McKeown, and T. Anderson, H. Balakrishnan, G. Parulkar, L. Peterson, J. Rexford, S. Shenker, J. Turner, “OpenFlow: Enabling Innovation in Campus Networks”, SIGCOMM Comput. Commun. Rev., April 2008, 38, pp. 69-74, which is incorporated herein by reference in its entirety) has established (1) flow tables as a standard data-plane abstraction for distributed switches, (2) a protocol for the centralized controller to install forwarding rules and query state at switches, and (3) a protocol for the switches to forward to the controller packets not matching any rules in its switch-local forwarding table. The programming of the centralized controller is referred to as “SDN programming”, and a network operator who conducts SDN programming as an “SDN programmer”, or just “programmer”.

Data communication networks, referred to herein as “networks”, can include interconnected switches, virtual switches, hubs, routers, and/or other devices configured to handle data packets as they pass through the network. These devices are referred to herein as “network elements”. The term “switch” is used synonymously with “network element”, unless otherwise noted.

Sources and destinations may be considered endpoints on the network. Endpoint systems, along with the users and services that reside on them, are referred to herein as “endpoints”. The term “host” is used synonymously with endpoint. As used herein, the term “data forwarding element” refers to an element in the network that is not an endpoint, and that is configured to receive data from one or more endpoints and/or other network elements and to forward data to one or more other endpoints and/or other network elements.

Network elements, including data forwarding elements, may have “ports” at which they interconnect with other devices via some physical medium, such as Ethernet cable or optical fibre. A switch port which connects the port to an endpoint as an “edge port” and the communication link connecting the endpoint to the switch port is referred to as an “edge link”. A switch port which connects the port to another switch port (typically on a different switch) is referred to as a “core port” and the link connecting the two switches as a “core link”.

The terms “topology” and “network topology” refer to the manner in which switches are interconnected. A network topology is often mathematically represented as a finite graph, including a set of nodes representing network elements, a set of links representing communication links, and a function indicating, for each link, the two network elements connected by the link as well as the ports at which the link attaches on the two network elements. This information can be augmented with extra attributes of nodes and links, such as the bandwidth of each link.

A “packet” or “frame” is the fundamental unit of data to be communicated in a packet-switched computer network. A packet contains a sequence of bits, wherein some portion of those bits, typically the initial bits, form a “header” (also referred to as a “frame header” or “packet header”) which contains information used by the network to provide network services. For example, an Ethernet frame header includes the sender (also known as the source) and the recipient (also known as the destination) Ethernet addresses. The header is structured into “fields” which are located in specific positions in the header. For example, the Ethernet frame header includes fields for the source and destination Ethernet addresses of the frame. The symbolic notation p.a is defined to denote the value of field a in the packet p.

The term “forwarding behavior” denotes the manner in which packets are treated in a network, including the manner in which packets are switched through a sequence of switches and links in the network. The forwarding behavior may also refer to additional processing steps applied to packets during forwarding, such as transformations applied to a data packet (e.g. tagging packets with virtual local area network (VLAN) identifiers) or treating the packet with a service class in order to provide a quality of service (QoS) guarantee. The term “global forwarding behavior of a packet” is used to refer to the manner in which a packet is forwarded from the edge port at which it enters the network to other edge ports at which it exits. The phrase “global packet forwarding behavior” refers to a characterization of the global forwarding behavior of all packets.

Network elements include a forwarding process, which is invoked on every packet entering the network element, and a control process whose primary task is to configure data structures used by the forwarding process. In cases of pure software switches (e.g. Open VSwitch (OVS)), the forwarding process and control process both execute on the same physical processor. In other cases, the forwarding process executes on a special-purpose physical processor, such as an Application-Specific Integrated Circuit (ASIC), a Network Processor Unit (NPU), or dedicated x86 processors. In these cases, the control process runs on a distinct physical processor. In most cases, the forwarding process processes packets using a relatively limited repertoire of processing primitives and the processing to be applied to packets is configured through a fixed collection of data structures. Examples include IP prefix lookup tables for next hop destination, or access control lists consisting of L3 and L4 attribute ranges and permit/deny actions.

Network elements may implement a protocol similar to OpenFlow (https://www.opennetworking.org/about/onf-documents; see, e.g., “OpenFlow Switch Specification, Version 1.0.0, Dec. 31, 2009, which is incorporated herein by reference in its entirety), wherein a network element has a local collection of prioritized rules with which to process packets, known herein as a “rule set”. Such network elements are designated herein as “Openflow-like network elements”. Each rule may have a priority level, a condition that specifies which packets it may apply to, and a sequence of actions with which to process applicable packets. The sequence of actions itself may be referred to as an (composite) action. Openflow-like network elements communicate with a component known as the “controller,” which may be implemented as one or more computers such as control servers. The controller interacts with an Openflow-like network element in order to control its packet processing behavior, typically by configuring the rule sets of the Openflow-like network elements. In addition, an OpenFlow-like network element implements a mechanism for diverting certain packets (in whole or in part) from the forwarding process to the controller, wherein the set of packets to be forwarded (in whole or in part) to be sent to the controller can be configured dynamically by the controller.

### SUMMARY

In one embodiment the present invention relates to a method in a data communications network comprising a plurality of data forwarding elements each having a set of forwarding rules and being configured to forward data packets according to the set of forwarding rules, the data communications network further comprising at least one controller including at least one processor configured to update forwarding rules in at least some of the plurality of data forwarding elements, the method comprising (a) accessing, at the at least one controller, an algorithmic policy defined by a user in a general-purpose programming language other than a language of data forwarding element forwarding rules, which algorithmic policy defines a packet-processing function specifying how data packets are to be processed through the data communications network; (b) applying the packet-processing function at the at least one controller to process a first data packet through the data communications network, whereby the first data packet has been delivered to the controller by a data forwarding element that did not contain a set of forwarding configurations capable of addressing the data packet; (c) recording one or more characteristics of the first data packet queried by the at least one controller in applying the packet-processing function to process the first data packet, and a manner in which the first data packet is processed by the packet-processing function; (d) defining forwarding rules specifying that data packets having the one or more queried characteristics are to be processed in the manner in which the first data packet is processed; and (e) applying the derived forwarding rules to the at least one data forwarding element, whereby the method is used to implement any of the following network services: Ethernet (L2) network services, IP routing services, Firewall services, Multi-tenant cloud services, including virtual address spaces, Network Address Translation (NAT) services, Server load balancing services, ARP proxy, DHCP services, DNS services, Traffic monitoring services (forwarding traffic of desired classes to one or more monitoring devices connected to the network), Traffic statistics collection, Service chaining system where packets are delivered through a chain of services, according to user-specified per-traffic class service chain configuration, where services may be realized as traditional network appliances or as virtualized as virtual machines running on standard computing systems, Traffic engineering over wide-area network (WAN) connections, or Quality of service forwarding, for example to support voice and video network applications.

In a first more specific embodiment, the method comprises (a) accessing, at the at least one controller, an algorithmic policy defined by a user comprising one or more programs written in a general-purpose programming language other than a language of data forwarding element forwarding rules, which algorithmic policy in particular defines a packet-processing function specifying how data packets are to be processed through the data communications network; (b) applying the packet-processing function at the at least one controller to process a first data packet through the data communications network, whereby the first data packet has been delivered to the controller by a data forwarding element that did not contain a set of forwarding configurations capable of addressing the data packet; (c) recording one or more characteristics of the first data packet queried by the at least one controller in applying the packet-processing function to process the first data packet, and a manner in which the first data packet is processed by the packet-processing function; (d) defining forwarding rules specifying that data packets having the one or more queried characteristics are to be processed in the manner in which the first data packet is processed; and (e) applying the derived forwarding rules to the at least one data forwarding element, wherein (1) the user-defined algorithmic policy declares state components including variables of any type, sets containing elements of any type, and finite key-value maps with arbitrary key and value types, and the packet processing function accesses said state components when processing a packet through read or write operations, (2) the dependency of an algorithmic policy execution on declared state components accessed during the execution is recorded in a state dependency table, and (3) when a state component is changed the state dependency table is used to determine the packet processing function executions which may no longer be valid, and the derived forwarding rules for invalidated executions are removed from the at least one data forwarding element and updates of other network element forwarding rules are made if needed to ensure correctness in the absence of the removed rules.

In a refinement of the method of the latter embodiment, state component update commands issued by external agents according to specific communication protocol, are accepted and executed by the at least one controller to accomplish changes to declared state components. Also encompassed is that a group of state component update commands are accepted and executed collectively as an atomic action, guaranteeing both atomicity, meaning that either all actions are executed or none are, and isolation, meaning that any executions of the packet processing function use values of state components that result from execution of all actions in transactions.

In a further refinement of the method of the first more specific embodiment, state component values are written to durable storage media by the at least one controller when state components are changed, in order to enable the at least one controller to resume execution after a failure.

In another refinement of the method of the first more specific embodiment, (1) the packet processing function is permitted to update the values of declared state components during execution and (2) the method of defining (the defining of) forwarding rules after execution of the packet processing function on a packet is modified to not define forwarding rules after an execution if further executions of the packet processing function on the packets described by the forwarding rules to be defined would lead to further changes to state components, and (3) the method of updating forwarding rules is modified so that after a change to a collection of state components, any forwarding rules which were previously applied to network elements and which would match at least one packet that would cause a change to one or more state components if the packet processing function were executed upon it, are removed from network elements in which they are applied and any remaining forwarding rules are repaired to ensure correctness in the absence of the removed rules. In the latter method, a read-write interference detection algorithm can be used to determine whether forwarding rules may be defined and applied following an execution of the packet processing function on a packet by the at least one controller.

In another refinement of the method of the first more specific embodiment, (1) when the one or more controller executes the packet processing function on a packet and defines and applies forwarding rules to network elements, the controller stores said packet in memory and (2) after a change to state components is made and the dependency table is used to determine invalidated executions, the packet processing function is executed on the stored packet for each invalidated execution in such a way that (a) any executions which would perform a change to state component are abandoned and the state components are not updated, and (b) executions which do not perform state changes are recorded and used to define new forwarding rules, and (3) the cancelUpdates method is used to determine the overall update to apply to network elements concerning the forwarding rules for invalidated executions that should be removed and the new forwarding rules defined based on packet processing function executions on packets stored for invalidated executions that should be introduced.

In another refinement of the method of the first more specific embodiment, the at least one controller accesses a collection of functions defined by a user in a general-purpose programming language where each function defines a procedure to perform in response to various network events, such as network topology changes, and the at least one controller recognizes, through interaction with network elements, when network events occur and executes the appropriate user-defined function for the event.

In another refinement of the method of the first more specific embodiment, the algorithmic policy is permitted to initiate a timer along with a procedure to execute when the timer expires, and the at least one controller monitors the timer and executes the associated procedure when the timer expires.

In one of two further refinements of the method of the first more specific embodiment or of any of the latter two refined methods, the algorithmic policy permits (1) definition of new traffic counters for either one or both packet and byte counts, (2) the packet processing function to increment said counters, (3) the packet processing function and any other procedures defined in the algorithmic policy, such as functions associated with network events or timer expirations, to read the values of said counters, (4) the registration of computations to be performed when a counter is updated, and (5) external processes to query said counters through a defined communication protocol. The distributed traffic flow counter collection method is utilized by the at least one controller to monitor flow rule counters in network elements at the ingress point of traffic flows and to correlate flow rule counter measurements with traffic counters declared in the algorithmic policy. In the other further refinement, (a) the at least one controller collects port statistics, including numbers of packets and bytes received, transmitted and dropped, from network elements, (b) programs comprising the algorithmic policy are permitted to read port statistics, (c) procedures are permitted to be registered to be invoked when port statistics for a given port are updated and the at least one controller invokes registered procedures on receipt of new port statistics, and (d) a communication protocol is utilized by external processes to retrieve collected port statistics.

In another refinement of the method of the first more specific embodiment, (a) programs comprising the algorithmic policy are permitted to construct, either during packet processing function or other procedures, a frame and to request that it be sent to any number of switch ports, (b) the at least one controller delivers the frames requested to be sent, and (c) the defining of forwarding rules after packet processing function execution is modified so that if an execution causes a frame to be sent, then no forwarding rules are defined or applied to any network elements for said execution.

In a further refinement of the method of the first more specific embodiment, (a) the packet processing function is permitted to access attributes of packets which are not accessible in forwarding rules applicable to network elements, and (b) the defining of forwarding rules after a packet processing execution is modified so that no forwarding rules are derived for executions which accessed attributes which were not accessible in forwarding rules applicable in network elements.

In another refinement of the method of the first more specific embodiment,

(a) the packet processing function is permitted to modify the input packet and (b) the defining of forwarding rules after a packet processing function execution is modified so that the defined forwarding rules collectively perform the same modifications as performed in the packet function execution. The packet processing function can modify the input packet, e.g., by inserting or removing VLAN or MPLS tags, or writing L2, L3, or L4 packet fields. In this method, the defining of forwarding rules after a packet processing function execution can be modified so that the defined forwarding rules perform any required packet modifications just before delivering a copy of the packet on an egress port and no packet modifications are performed on any copy of the packet forwarded to another network element.

In yet another refinement of the method of the first more specific embodiment (a) one or more packet queues are associated with each port, where the packet queues are used to implement algorithms for scheduling packets onto the associated port, (b) the route returned by the packet processing function is permitted to specify a queue for every link in the route, where the queue must be associated with the port on the side of the link from which the packet is to be sent, and (c) forwarding rules defined for an execution of the packet processing function are defined so that rule actions enqueue packets onto the queue specified, if any, by the route returned from the execution.

In another refinement of the method of the first more specific embodiment, the defining of forwarding rules after a packet processing function execution is modified so that the route returned by the packet processing function is checked to ensure that it does not create a forwarding loop, and forwarding rules are only defined and applied to network elements if the returned route is safe.

In a further refinement of the method of the first more specific embodiment, the defining of forwarding rules after a packet processing function execution is modified to apply a pruning algorithm to the returned forwarding route, where the pruning algorithm eliminates network elements and links that are not used to deliver packets to destinations specified by the returned route.

In another refinement of the method of the first more specific embodiment, forwarding rules are defined by using a trace tree developed from tracing packet processing function executions, wherein (a) the packet processing function is permitted to evaluate conjunctions of packet field conditions, (b) T nodes of trace trees are labeled with a set of field assertions, and (c) enhanced trace tree compilation is used to define forwarding rules from trace trees with T nodes labeled by sets of field assertions.

In a refinement of the method of the first more specific embodiment, forwarding rules are generated to implement packet processing function executions by implementing (a) classifiers at edge network elements that add a label to the packet headers and forward packets to their next hop for each packet that arrives on an ingress port and that remove labels for each packet destined to an egress port, and (b) label-based rules to core network elements to forward based on labels.

In another refinement of the method of the first more specific embodiment, (a) the packet processing function is supplied with a network topology which does not correspond exactly with the physical network topology, and (b) after obtaining the returned route from an execution of the packet processing function on a packet, the returned route is transformed into a route on the physical network topology.

In another embodiment of the first more specific method, one or more network links are implemented as tunnels through IPv4 or IPv6 networks.

In yet another refinement of the method of the first more specific embodiment, the packet processing function is permitted to access the ingress port of a packet and the defining of forwarding rules after packet processing execution is modified as follows: (a) a unique identifier is associated with each possible ingress port, and (b) the forwarding rules defined for the packet's ingress port write the unique identifier into the packet header, and (c) forwarding rules defined for packets arriving at a non-ingress port match on the unique ingress port identifier in the packet header whenever the rule is intended to apply to a subset of packets originating at a particular ingress port.

In another embodiment of the first more specific method, (a) packet processing function execution is modified to develop a trace graph representation of the packet processing function, and (b) forwarding rules are compiled from trace graph representation. In a more specific embodiment, a static analysis algorithm is applied to the packet processing function in order to transform it into a form which will develop a trace graph representation during tracing of the packet processing function. In another more specific embodiment, a multi-table compilation algorithm is used to compile from a trace graph representation to multi-table forwarding rules for multi-table network elements. The forwarding rule compilation algorithm can be traceGraphCompile.

In a further embodiment of the first more specific method, a graphical user interface is presented to human users that: (a) depicts the network topology of switches, links and hosts and depicts the traffic flows in the network using a force-directed layout, (b) provides the user with buttons and other GUI elements to select which traffic flows to display on the visualization, and (c) illustrates the amount of traffic flowing on a traffic flow by the thickness of the line representing the traffic flow.

In another embodiment of the first more specific method, (1) a rule caching algorithm is applied to determine which rules to apply to a network element, among all rules which could be applied to the given network element and (2) packets arriving at a network element which match rules that are not applied by the rule caching algorithm to the network element are processed by the controller without invoking the packet processing function. The rule caching algorithm can select rules to apply to network elements in order to maximize the rate of packets or bytes transferred, by estimating, based on flow measurements, the rate of packets or bytes which would be received for each possible forwarding rule and selecting a collection of rules to apply which has the highest expected rate of packets or bytes transferred.

In the methods of the present invention, network elements can be, but are not limited to, the following: Open VSwitch (OVS), Linc software switch, CPQD soft switch, Hewlett-Packard (HP) (FlexFabric 12900, FlexFabric 12500, FlexFabric 11900, 8200 zl, HP 5930, 5920, 5900, 5400 zl, 3800, 3500, 2920), NEC (PF 5240, PF 5248, PF 5820, PF 1000), Pluribus (E68-M, F64 series), NoviFlow NoviSwitches, Pica8 switches, Dell-capable switches, IBM OpenFlow-capable switches, Brocade OpenFlow-capable switches, and Cisco OpenFlow-capable switches.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a flow chart illustrating how packets may be processed at an Openflow-like network element;

FIG. 2 is a drawing of an exemplary arrangement of components of an Openflow-like network; EP1-3 are endpoints; NE1-3 are network elements. Communication links between network elements or between network elements and endpoints are shown as solid lines, and logical control channels between network elements and the controller are shown as dashed lines;

FIG. 3 is a drawing of exemplary components of a network controller in accordance with some embodiments; NE (Network Element) Control Layer communicates with network elements; Core executes the user-defined algorithmic policy, maintains information about the policy and network state, and issues configuration commands to the NE Control Layer; f is a user-defined algorithmic policy;

FIG. 4 is a flow chart of exemplary high-level steps to process a packet arriving at a network element in accordance with some embodiments;

FIG. 5 depicts an example trace tree in accordance with some embodiments;

FIG. 6 illustrates an exemplary partial function that may be encoded in a trace tree in accordance with some embodiments, in the form of the searchTT method;

FIG. 7 illustrates exemplary steps to augment a trace tree in accordance with some embodiments, using the AugmentTT algorithm;

FIG. 8 illustrates exemplary steps to convert a single trace to a trace tree in accordance with some embodiments, using the TraceToTree algorithm;

FIG. 9 illustrates an example of augmenting an initially empty trace tree with several traces, in accordance with some embodiments;

FIG. 10 illustrates exemplary steps to build a flow table from a trace tree in accordance with some embodiments, using the buildFT algorithm;

FIG. 11 illustrates an exemplary context-free grammar for trace trees that may be used in accordance with some embodiments, in connection with the optBuildFT algorithm;

FIG. 12 lists exemplary equations of an attribute grammar that that may be used in accordance with some embodiments, in connection with the optBuildFT algorithm;

FIG. 13 is a drawing of exemplary components of a network system in which an algorithmic policy references an external database, in accordance with some embodiments; g is an invalidator component, while all other elements are as listed with reference to FIG. 3;

FIG. 14 illustrates exemplary steps to reduce the length of traces produced from executing an algorithmic policy in accordance with some embodiments, using the compressTrace algorithm;

FIG. 15 illustrates exemplary steps to calculate an incremental update to a rule set from an incremental update to a trace tree in accordance with some embodiments, in order to maintain a rule set in correspondence with a trace tree as specified by the optBuildFT method, using the incrementalCompile algorithm;

FIG. 16 illustrates exemplary steps to optimize the rule sets of network elements in accordance with some embodiments, using the CoreOptimize algorithm;

FIG. 17 shows exemplary graphs of the mean packet miss rate as a function of the number of concurrent flows for a hand-optimized controller, whose graph is labelled “Exact”, and a controller expressed using an algorithmic policy and executed using methods of some embodiments, whose graph is labelled “AlgPolicyController”;

FIG. 18 shows exemplary graphs of the mean packet miss rate as a function of the number of concurrent flows per host for a hand-optimized controller, whose graph is labelled “Exact”, and a controller expressed using an algorithmic policy and executed using methods of some embodiments, whose graph is labelled “AlgPolicyController”;

FIG. 19 shows an exemplary graph of the mean time to establish a TCP connection as a function of the number of concurrent TCP connections initiated using a network with three HP 5406 OpenFlow switches for a hand-optimized controller, whose graph is labelled “Exact”, a controller expressed using an algorithmic policy and executed using methods of some embodiments, whose graph is labelled “AlgPolicyController”, and a traditional (i.e., non-OpenFlow-based) hardware implementation, whose graph is labelled “Normal”;

FIG. 20 is a schematic diagram of an exemplary computing environment in which some embodiments may be implemented; and

FIG. 21 is a flow chart illustrating an exemplary method for managing forwarding configurations in accordance with some embodiments.

FIG. 22 illustrates exemplary steps to optimize a collection of flow table operations by calculating a reduced number of flow table operations that accomplish the same effect as the input sequence of updates.

FIG. 23 illustrates an exemplary fragment of an algorithmic policy in which the algorithmic policy programming language, implemented in Java, has been extended with a single command, “sendPacket(Ethernet frame)” which allows the program to send an Ethernet frame, where the Ethernet frame is modeled as a Java object of class “Ethernet”.

FIG. 24 illustrates an exemplary algorithmic policy that demonstrates the use of a TAPI which permits the program to specify packet. In this example code, the packet modifications are added as optional arguments to the “unicast” and “multicast” Route objects specified as return values of the function.

FIG. 25 illustrates exemplary steps used in certain embodiments to eliminate network elements and ports from an input forwarding tree while preserving the forwarding behavior (same packets delivered along same paths) of the input forwarding tree.

FIG. 26 illustrates an exemplary algorithmic policy consisting of n conditional tests, each consisting of k=3 clauses.

FIG. 27 illustrates an exemplary trace tree that may be developed from the program of FIG. 26 when the trace tree data structure permits T nodes to be labeled with only a single assertion on a packet header field.

FIG. 28 illustrates an exemplary trace tree that may be developed from the program of FIG. 26 when the trace tree data structure is extended to permit T nodes to be labeled with multiple assertions on packet header fields.

FIG. 29 illustrates an exemplary Graphical User Interface (GUI) depicting the interactive and graphical display of network topology, host placement, and traffic flows, intensity and direction.

FIG. 30 illustrates an exemplary representation of a trace graph using the Haskell programming language.

FIG. 31 illustrates an exemplary algorithm expressed in the Haskell programming language for calculating rules for a multi-table network element from the exemplary trace graph representation described in FIG. 30.

FIG. 32 illustrates exemplary supporting algorithms for the algorithm of FIG. 31, expressed in the Haskell programming language.

### DETAILED DESCRIPTION

Some embodiments described herein relate to the control of software-defined networks (“SDN” s), including those using OpenFlow-compatible switches, by which is meant any electronic devices, such as switches, routers, or general purpose computers performing essential packet-forwarding services and implementing the OpenFlow protocol or similar control protocols.

Some embodiments may provide benefits such as allowing users to customize the behavior of a network with nearly arbitrary programs, such as algorithmic policies, which specify desired forwarding behavior of packets without concern for the configuration formats accepted by the network elements. Another potential benefit of some embodiments may be to automatically, dynamically, efficiently and optimally generate configurations for network elements from such algorithmic policies, for the purpose of achieving high performance. However, embodiments are not limited to any of these benefits, and it should be appreciated that some embodiments may not provide some or any of the above-discussed benefits.

One challenge in engineering a successful SDN lies in providing a programming environment (including language, libraries, runtime system) that is both convenient to program and expressive enough to allow a wide variety of desired network behaviors to be implemented. Another challenge is achieving adequate network performance, so that the SDN does not substantially diminish network performance compared with traditional network control techniques. No existing systems succeed in achieving these goals.

It is recognized that some existing systems, such as “NOX” (Gude, N., Koponen, T., Pettit, J., Pfaff, B., Casado, M., McKeown, N. and Shenker, S., “NOX: Towards an Operating System for Networks”, SIGCOMM Comput. Commun. Rev., July 2008, 38, pp. 105-110), Beacon (https://openflow.stanford.edu/display/Beacon/Home), and “Floodlight” (http://floodlight.openflowhub.org), provide basic SDN controllers for OpenFlow-capable network elements. These controllers allow SDN programmers to write arbitrary programs for controlling OpenFlow network elements, and hence make it possible for a programmer to express arbitrary network behaviors and to achieve high performance (subject to functional and performance constraints of the network elements). However, these tools require that the programmer explicitly manipulate the network element configuration—a tedious, complex, and error prone activity, if done in a way to achieve high performance. As a result, it is in practice very difficult to build reliable and fast networks using these tools.

It is recognized that some other systems, including “Frenetic” (Foster, N., Harrison, R., Freedman, M., Monsanto, C., Rexford, J., Story, A. and Walker, D., “Frenetic: a network programming language”, Proceedings of the 16th ACM SIGPLAN ICFP 2011, 2011, pp. 279-291) and “NetCore” (Monsanto, C., Foster, N., Harrison, R. and Walker, D., “A compiler and run-time system for network programming languages”, Proc. of POPL '12, 2012, pp. 217-230), provide enhanced, declarative programming systems for OpenFlow networks. These systems attempt to make programming such networks easier and more convenient. Both of these systems require programmers to express network configurations in terms of packet processing rules. Although these systems alleviate some of the problems with programming these rules (as compared with basic SDN controllers), this approach still requires programmers to convert their desired behavior into rules and creates a two-tiered model in which undetected errors can arise when the program logic that generates rules and the rules themselves are not consistent.

Furthermore, both Frenetic and NetCore have inefficient implementations. Frenetic uses only exact-match OpenFlow rules (discussed further below). When using exact-match rules, many more rules are required to handle the overall traffic in the network than is supported in the rule tables of network elements. Hence, packets often fail to match in the local rule set of a network element, and rules present in the rule sets of network elements must often be evicted to make space for other rules. This causes a substantial number of packets to be diverted to the central controller, and the penalty for such a delay is typically severe, taking anywhere from hundreds of microseconds to tens of milliseconds. In contrast, packets forwarded directly by the network element are typically forwarded within a few nanoseconds. As a result, the performance of the network, in terms of throughput and latency experienced by users of the network, suffers when significant numbers of packets are diverted to the controller. It is recognized that NetCore uses switch resources well by taking advantage of “wildcard” rules (discussed further below), but uses a compilation algorithm that has exponential time complexity and that fails to optimize generated rule sets in several ways. In addition, NetCore's language is very limited and does not permit the user to express behaviors that are typical in networks, such as forwarding along shortest paths in a network. As a result, NetCore is used in practice only as an intermediate language in compilers accepting network controllers written in more expressive languages.

By contrast, some embodiments described herein allow users to program in a highly expressive and convenient language for specifying the forwarding behavior of a network without regard to the rules that network elements should use for forwarding packets. In some embodiments, programmers may write nearly arbitrary programs to express the behavior of an SDN, using a variety of programming languages, whereby the programs specify packet forwarding behavior rather than network element configurations. Some embodiments efficiently generate rule sets for network elements that use their critical resources optimally so that the overall network performs at a level comparable to a non-SDN network. In some embodiments, the network system may use automated algorithms to configure network elements to achieve the behavior specified by the user-defined program, improving performance by increasing the frequency with which packets are processed locally and independently within network elements. Some embodiments may provide less complicated and less error-prone methods to implement SDNs than traditional methods. Some embodiments may allow the SDN programmer to program networks with a simple, flexible programming method, while using automated procedures to control network elements to achieve correct and efficient network services. However, embodiments are not limited to any of these benefits, and it should be appreciated that some embodiments may not provide any of the above-discussed benefits and/or may not address any of the above-discussed deficiencies recognized in conventional techniques.

In some embodiments, the SDN programmer may apply a high-level algorithmic approach to define network-wide forwarding behaviors of network flows. The programmer may simply define a packet processing function f, expressed in a general-purpose, high-level programming language (e.g., a programming language other than the programming language in which forwarding rules and/or other forwarding configurations are programmed at the data forwarding elements), which appears conceptually as though it is run by the centralized controller on every packet entering the network. In other words, the programmer may be presented with the abstraction that his program f is executed on every packet passing through the network, even though in practice the network may avoid actually executing f on every packet at the central controller, utilizing network elements to perform the processing locally instead. In designing the function f, is some embodiments the programmer need not adapt to a new programming model, but rather may use standard programming languages to design arbitrary algorithms to classify input packets and compute how packets should be forwarded to organize traffic. Such programs are referred to as “algorithmic policies” or “user-defined algorithmic policies” and refer to this model as “SDN programming of algorithmic policies”. Algorithmic policies and declarative policies do not exclude each other; in fact, algorithmic programming can be useful in implementing compilers or interpreters for declarative languages for network policies.

Some embodiments may provide the SDN programmer with a simple and flexible conceptual model. It is recognized, however, that a naïve implementation may come at the expense of performance bottlenecks. Conceptually, in some embodiments f may be invoked on every packet, potentially leading to a computational bottleneck at the controller; that is, the controller may not have sufficient computational capacity to literally invoke f on every packet. Also, it is recognized that the bandwidth demand on the communication infrastructure to send every packet through the controller may not always be practical. It is further recognized that these bottlenecks may be in addition to the extra latency of forwarding all packets to the controller for processing as described in Curtis, A., Mogul, J., Tourrilhes, J., Yalagandula, P., Sharma, P. and Banerjee, S., “DevoFlow: Scaling Flow Management for High-Performance Networks”, Proceedings of the ACM SIGCOMM 2011 conference, 2011, pp. 254-265.

Accordingly, some embodiments may achieve the simplicity, flexibility, and expressive power of the high-level programming model, along with incorporated techniques to address some or all of the aforementioned performance challenges. In some embodiments, SDN programmers may be able to enjoy simple, intuitive SDN programming, and at the same time achieve high performance and scalability. However, embodiments are not limited to any of these benefits, and it should be appreciated that some embodiments may not provide some or any of the above-discussed benefits.

Various embodiments may make use of any or all of several techniques discussed herein. In some embodiments, a user may define a packet-processing policy in a general-purpose programming language, specifying how data packets are to be processed through the network via the controller. The user-defined packet-processing policy may be accessed at the controller, and forwarding configurations for data forwarding elements in the network may be derived therefrom. Any suitable technique(s) may be used to derive network element forwarding configurations from the user-defined packet-processing policy, including static analysis and/or dynamic analysis techniques. For example, in some embodiments, the user-defined packet-processing policy may be analyzed using a compiler configured to translate programming code of the packet-processing policy from the general-purpose programming language in which it is written to the programming language of the network element forwarding rules. Alternatively or additionally, in some embodiments the user-defined packet-processing policy may be analyzed (e.g., modeled) at runtime while the policy is applied to process data packets at the controller.

In some embodiments, the user's program may be executed in a “tracing runtime” that instruments the user's program so that when run, the tracing runtime will record certain steps performed by the program, these recordings being named traces. In some embodiments, a “dynamic modeler” may accumulate traces over numerous runs of the program to dynamically generate an abstract model of the program. In some embodiments, a “dynamic optimizer” may use this dynamically learned model to generate configurations for network elements using several optimization techniques to generate optimized configurations for some or all of the network elements, taking advantage of hardware features of the network elements and/or network topology constraints. Some embodiments provide efficient implementations of the dynamic optimization, including “incremental” algorithms to convert a change in the model of the algorithmic policy into a change in the network element configurations.

Some embodiments may address the aforementioned challenges of SDNs by providing the programmer with a highly expressive (since it allows arbitrary deterministic algorithms, i.e., those expressible on a deterministic Turing machine) and convenient (since there is no need to specify complex network configurations) programming interface. Additionally, some embodiments may solve aforementioned performance challenges in implementing SDNs by more effectively using hardware features in network elements to increase the frequency with which packets arriving at a network element can be processed locally within the network element. It is appreciated that such increased packet processing locality may have at least two consequences. On the one hand, locality may result in fewer packets being delayed by diversions to the centralized controller. On the other hand, locality may reduce the utilization of communication links between the network elements and the controller and may reduce the computational load placed on the controller, both of which typically result in reduced time to process a diverted packet. Overall, the effect may be to reduce the expected delay that packets experience in traversing the network, potentially resulting in improved network performance. However, embodiments are not limited to any of these benefits, and it should be appreciated that some embodiments may not provide any of the above-discussed benefits and/or may not address any of the above-discussed deficiencies that have been recognized in conventional techniques.

Accordingly, some embodiments relate to a data communication network comprising a multiplicity of network elements and a controller that implements a user-defined (user's) algorithmic policy specifying global packet forwarding behavior. The user's algorithmic policy is understood to be an algorithm that accesses packet and optionally network state information through a defined interface and specifies packet forwarding behavior, i.e., how packets should be processed. In some embodiments, the algorithm need not specify how network elements are to be configured. In particular embodiments, the algorithm can access not only packet and network state information but also information external to the network, e.g. a database maintained by some external entity.

In some embodiments, the user-defined algorithmic policy can specify a path through the network along which path a packet should be forwarded. Alternatively or additionally, it can specify a subtree of the network along which subtree a packet should be forwarded.

In a more specific embodiment, the network's controller may use a trace tree to model the user-defined algorithmic policy. The trace tree may be a rooted tree in which each node t has a field typeₜ, whose value is one of the symbols L, V, T or Ω. The meaning of these symbols is discussed below. In some embodiments, the controller may construct the trace tree iteratively by executing the user's algorithmic policy on a packet, recording a trace consisting of the sequence of function applications performed during the execution of the algorithmic policy, and using said trace and results returned by the algorithmic policy for initiating or building out/augmenting the trace tree. The same operation may then be performed on the next packet, and so forth. In some embodiments, the controller can make use of algorithm AugmentTT, discussed below, for initiating and building out a trace tree. In a particular version of this embodiment, the trace tree may lack T nodes.

In a further more specific embodiment, the controller may model the user's algorithmic policy as a trace tree and use the trace tree for generating rule sets for network elements so that the network comprising the network elements forwards packets in accordance with the algorithmic policy. In some embodiments, the controller may not execute the user's algorithmic policy on all packets, but only on packets that have been forwarded to the controller by a network element because they failed to match any local rule. Resulting traces and results may be recorded and used for updating the trace tree and generating new rule sets.

In some embodiments, the controller can use algorithms buildFT or optBuildFT, discussed below, for compiling rule sets from trace trees. To enhance network performance, in some embodiments the controller can use an incremental algorithm for maintaining a correspondence between trace tree and rule sets. The use of such an algorithm may reduce the instances in which addition of a new trace prompts recompilation of the entire trace tree. An example incremental algorithm is algorithm incrementalCompile, discussed below. To augment network performance, in some embodiments the controller can use an algorithm for optimizing and reducing the size of rule sets at network elements by partitioning packet processing responsibilities among different network elements based on their location in the network. A particular algorithm used in some embodiments can distinguish edge links and core links. An example algorithm is CoreOptimize, discussed below.

In particular embodiments of networks relying on trace trees for modeling users' algorithmic policies, the controller may execute the algorithmic policy through a collection of functions named “Tracing Application Programming Interface”, abbreviated “TAPI”, discussed below. TAPI may include methods for reading values of packets and/or network attributes such as topology information and/or host locations. In other particular embodiments, the TAPI may alternatively or additionally include methods for testing Boolean-valued attributes of packets.

In particular embodiments of networks relying on trace trees for modeling users' algorithmic policies, the algorithm compressTrace, discussed below, may be utilized for shortening traces produced from executions of the algorithmic policy.

Some embodiments relate to a method for establishing and operating a network comprising a multiplicity of network elements and a controller. In this exemplary method, a controller may (1) accept a user's algorithmic policy, (2) execute the algorithmic policy on a packet, (3) record a trace consisting of the sequence of function applications performed during the execution of the algorithmic policy, and (4) use said trace and results returned by the algorithmic policy for initiating or building out a trace tree.

In a more specific embodiment of the method, the algorithmic policy may be an algorithm that accesses packet and network state information through a defined interface.

In another more specific embodiment of the method, the algorithm may access packet, network state information, and/or network-external information relevant to determining packet forwarding policy through a defined interface.

In particular embodiments of the method, the controller may use algorithm AugmentTT, discussed below, for initiating or building out the trace tree.

In a further more specific embodiment of the method, the controller may use the trace tree for generating rule sets for network elements so that the network comprising the network elements forwards packets in accordance with the algorithmic policy. More specifically, in some embodiments the controller can compile rule sets using either algorithm buildFT or algorithm optBuildFT, discussed below.

In the latter embodiment, the controller can maintain a correspondence between trace trees and rule sets using an incremental algorithm. In some embodiments, the controller may utilize algorithm incrementalCompile, discussed below, for this purpose. To enhance network performance, in some embodiments the controller can utilize an algorithm for optimizing rule sets at network elements by partitioning packet processing responsibilities among different network elements based on their location in the network. More specifically, in some embodiments the latter algorithm distinguishes edge links and core links. Even more specifically, in some embodiments the algorithm is the algorithm CoreOptimize, discussed below.

In a particular embodiment, a controller may (1) accept a user's algorithmic policy, (2) execute the algorithmic policy on a packet, (3) record a trace consisting of the sequence of function applications performed during the execution of the algorithmic policy, (4) use said trace and results returned by the policy for initiating or building out a trace tree, and (5) use the trace tree for generating rule sets for network elements. In some embodiments, the controller may execute the algorithmic policy only on those packets that do not match in rule sets.

In particular embodiments, the controller may execute the algorithmic policy through a TAPI. In some embodiments, the TAPI may include methods for reading values of packets and/or network attributes such as topology information and/or host locations. In other particular embodiments, the TAPI may include methods for testing Boolean-valued attributes of packets.

In particular embodiments, the algorithm compressTrace, described below, may be utilized for shortening traces produced from executions of an algorithmic policy.

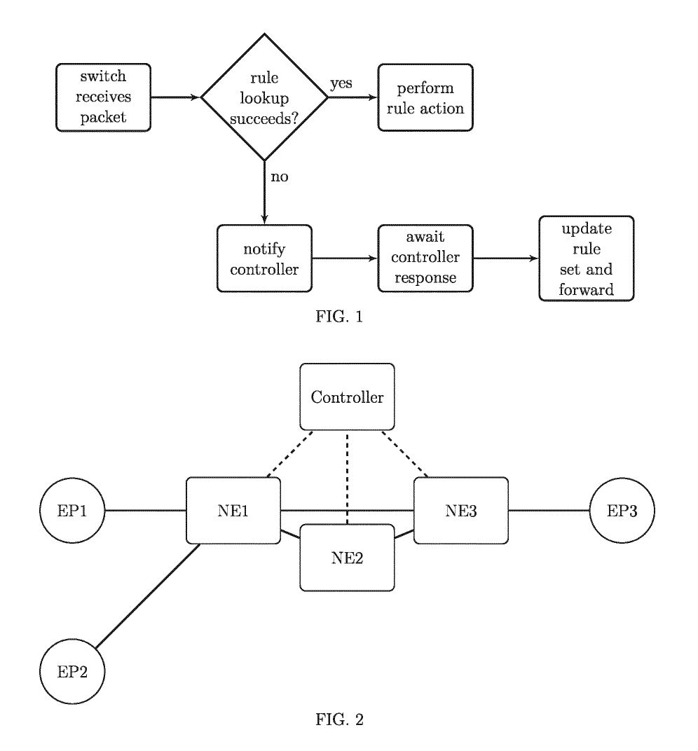

FIG. 1 is a flow chart indicating the processing of a packet arriving at an Openflow-like network element. When a packet arrives at a network element, the network element determines which rules, if any, are applicable to the packet (based on the conditions in the rules). If any applicable rules are found, the network element executes the action of the highest priority rule among these. If no applicable rules are found, the packet is forwarded to the controller. The controller may respond with an action to be performed for the packet, and may also perform other configuration commands on the network element; e.g., the controller may configure the network element rule set with a new rule to handle similar packets in the future. The rule set at an OpenFlow-like network element at any moment may be incomplete, i.e., the network element may encounter packets to which no rules in the rule set apply. The process just described and depicted in FIG. 1 may be used to add rules to an incomplete rule set as needed by traffic demands.

A network composed of OpenFlow-like network elements along with a controller is referred to herein as an “OpenFlow-like network”. FIG. 2 depicts an exemplary arrangement of some components that may exist in such a network, including three exemplary network elements (“NE”), three exemplary endpoints (“EP”) and one exemplary controller. One or more controllers may be present in an OpenFlow-like network, and may be implemented as one or more processors, which may be housed in one or more computers such as one or more control servers. The diagram in FIG. 2 depicts several exemplary communication links (solid lines) between NEs and between NEs and EPs. The diagram also depicts several exemplary logical control channels (dashed lines) used for communication between the NEs and the controller. If the NEs are OpenFlow-like network elements then (some version of) the OpenFlow protocol may be used to communicate between controller and network elements. The controller need not be realized as a single computer, although it is depicted as a single component in FIG. 2 for ease of description.

The condition in a rule of a rule set is herein known as a “match condition” or “match”. While the exact form and function of match conditions may vary among network elements and various embodiments, in some embodiments a match condition may specify a condition on each possible header field of a packet, named a “field condition”. Each field condition may be a single value, which requires that the value for a packet at the field is the given value, or a “*” symbol indicating that no restriction is placed on the value of that field. For certain fields, other subsets of field values may be denoted by field conditions, as appropriate to the field. As an example, the field conditions on the source or destination IP addresses of an IPv4 packet may allow a field condition to specify all IP addresses in a particular IPv4 prefix. An IPv4 prefix is denoted by a sequence of bits of length less than or equal to 32, and represents all IPv4 addresses (i.e. bit sequences of length 32) which begin with the given sequence of bits (i.e. which have the sequence of bits as a prefix).

An OpenFlow-like network element may allow additional flexibility in the match condition. In particular, a network element may allow a match condition to specify that the value of a given packet header field match a ternary bit pattern. A “ternary bit pattern” is a sequence where each item in the sequence is either 0, 1 or * (meaning “don't care”). The following condition describes when such a pattern pat on packet header field attr matches a packet pkt: suppose the value of attribute attr of pkt is written as a binary number with bits bₙ, . . . , b₀ and the pattern is the sequence pₙ, . . . , p₀. Then the pattern is said to match the packet if for every i ε{0 . . . n} such that pᵢ≠□ one has pᵢ=bᵢ. In addition, an OpenFlow-like network element may support matching on a range of values of a packet header field.

A match condition which specifies the exact value (i.e., rather than using patterns containing “*” bits or a range expression) for every field of a packet header is referred to as an “exact match condition” or “exact match,” and a rule whose match condition is an exact match condition is referred to as an “exact rule”. However, in some cases when certain packet attributes have certain values, other attributes are ignored even in an exact match. For example, if the ethType attribute is not IP (Internet Protocol) type, then the fields such as IP destination address typically are not relevant, and thus an exact match to a non-IP packet may be made without an exact match condition in the IP destination address field. The term “exact match” should be understood to include such matches disregarding inapplicable fields. Any match condition which is not an exact match condition is referred to as a “wildcard match condition” or “wildcard match”. A rule whose match condition is a wildcard match condition is referred to as “wildcard rule”.

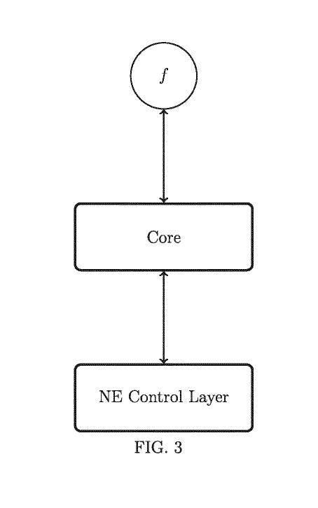

FIG. 3 depicts an exemplary arrangement of components of a network controller in accordance with some embodiments. “NE Control Layer” may include executable instructions to communicate with network elements, for example to send commands and receive notifications. In some embodiments, this component may be use various libraries and systems currently available for controlling network elements, for example, various basic OpenFlow controller libraries. The “Core” may include executable instructions that execute the user-defined algorithmic policy (e.g., in a tracing runtime), maintain information about the user-defined policy and the network state (the dynamic modeler), and/or issue configuration commands to the NE Control Layer (the dynamic optimizer). The component denoted “f” represents the user-defined algorithmic policy that is executed on some packets by the Core and specifies the desired forwarding behavior of the network.

In some embodiments, an SDN programmer may specify the path of each packet by providing a sequential program f, called an algorithmic policy, which may appear as if it were applied to every packet entering the network. Conceptually, the program f written by the user may represent a function of the following form (for concreteness, the notation of functional programming languages is borrowed to describe the input and output of f):

f:: (Packet,Env)->ForwardingPath

Specifically, f may take as inputs a packet header and in some embodiments an environment parameter, which contains information about the state of the network, including, e.g., the current network topology, the location of hosts in the network, etc. The policy f returns a forwarding path, specifying whether the packet should be forwarded and if so, how. To support multicast, the ForwardingPath result can be a tree instead of a linear path. However, an algorithmic policy is not limited to returning a path. In some embodiments, an algorithmic policy may alternatively or additionally specify other actions, such as sending new packets into the network, performing additional processing of a packet, such as modifying the packet, passing the packet through a traffic shaping element, placing the packet into a queue, etc. The return value of f therefore may specify global forwarding behavior for packets through the network. Except that it may conform to this type signature, in some embodiments f may involve arbitrary algorithms to classify the packets (e.g., conditional and loop statements), and/or to compute the forwarding actions (e.g., using graph algorithms). Unless otherwise specified, the terms “program” and “function” are used interchangeably herein when referring to algorithmic policies.

Although a policy f might in principle yield a different result for every packet, it has been appreciated that in practice a policy may depend on a small subset of all packet attributes and may therefore return the same results for all packets that have identical values for the packet attributes in this subset. As a result, many packets may be processed by fin the same way and with the same result. For example, consider the following algorithmic policy, which is written in the Python programming language (http://www.python.org), for concreteness:

def f(srcSwitch, inport, pkt):

locTable[pkt.eth_src] = (srcSwitch, inport)
if pkt.eth_dst in locTable:

(dstSwitch,dstPort) = locTable[pkt.eth_dst]
if pkt.tcp_dst_port == 22:

outcome = securePath(srcSwitch,dstSwitch)

else:

outcome = shortestPath(srcSwitch,dstSwitch)

outcome.append((dstSwitch,dstPort))

else:

outcome = drop

return outcome

In the above example policy, f assigns the same path to two packets if they match on source and destination MAC addresses, and neither of the two packets has a TCP port value 22. Hence, if f is invoked on one packet, and then a subsequent packet arrives, and the two packets satisfy the preceding condition, it is said that the first invocation of f is reusable or cacheable for the second.

Some embodiments therefore provide methods for observing both the outcome of f when applied to a packet as well as the sensitivity of that computation on the various packet attributes and network variables provided to f. By observing this information, some embodiments can derive reusable representations of the algorithmic policy and utilize this information to control network elements. The reusable representation is termed the “algorithm model” or “policy model”.

Some embodiments therefore include a component named “tracing runtime” which executes the user-defined algorithmic policy such that both the outcome and the sequence of accesses made by the program to the packet and environment inputs are recorded, that recording being named a “trace”. In particular, in some embodiments the program f may read values of packet and environment attributes and/or test boolean-valued attributes of the packet through a collection of functions, referred to herein as the “Tracing Application Programming Interface” (“TAPI”). The particular collection of functions and the specific input and output types can vary among embodiments, according to the details of the functionality provided by network elements and possibly the details of the programming language used to express the algorithmic policy. The following is an exemplary set of functions that can be included in the TAPI to access packet attributes:

readPacketField::(Packet, Field)->Value

testEqual::(Packet,Field,Value)->Bool

srcInIPPrefix::(Packet, IPPrefix)->Bool

dstInIPPrefix::(Packet, IPPrefix)->Bool

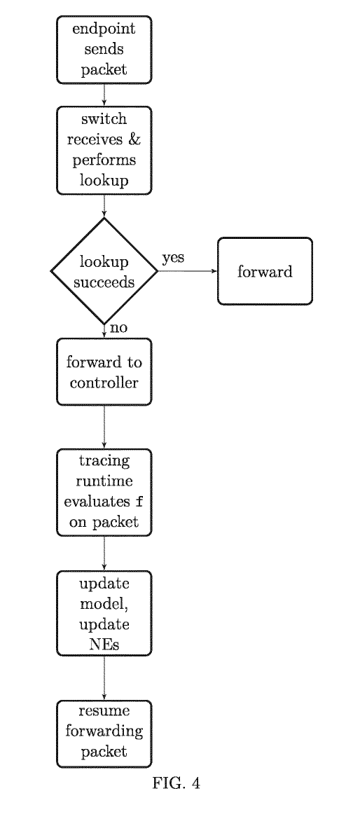

FIG. 4 depicts a flow chart of exemplary high-level processing steps that may be performed in some embodiments in a network control system which makes use of the algorithm model gained from observing the outcomes of f and its sensitivity to its input arguments by using the tracing runtime. The exemplary process begins when an endpoint sends a packet. A NE then receives the packet and performs a lookup in the local rule set. If the search succeeds, the specified action is performed immediately. Otherwise, the NE notifies the controller of the packet. The controller executes f using a method allowing it to observe the occurrence of certain key steps during the program execution. It then updates its model of f and then computes and performs NE configuration updates. Finally, it instructs the NE to resume forwarding the packet which caused the notification. In some embodiments, many packets may be processed in parallel by the system. Conceptually, this can be considered as having many instances of the flowchart in existence at any one moment.

In certain embodiments, the algorithmic policy may be extended to allow the SDN programmer to specify computations to execute in reaction to various other network events, such as network element shutdown and/or initialization, port statistics up-dates, etc.

In the example algorithmic policy above, the programmer uses idiomatic syntax in the programming language used to express the policy to access packet fields. For example, the programmer writes pkt. eth_src to access the Ethernet source address of the packet, following an idiom of the Python programming language, in which this policy is expressed. When executed in the tracing runtime, the execution of this expression ultimately results in an invocation of a method in the TAPI, such as readPacketField, but this implementation may be hidden from the user for convenience.

Several methods of modeling the behavior of an algorithmic policy are possible, with the methods varying in the degree of detail being modelled, and typically in the type of inferences that can be drawn from the model. One such type of model, termed the “trace tree” model, is presented in detail, although it should be understood that embodiments are not limited to this particular model.

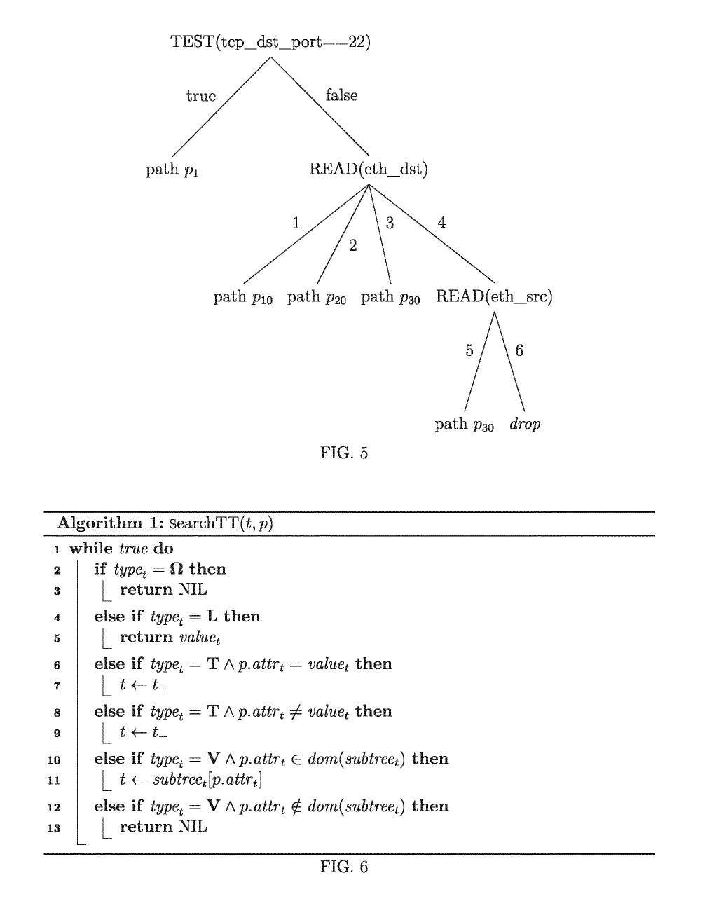

Prior to the description of the technical details, the trace tree model shall be illustrated with an example. Assume that the controller records each call to a function in the TAPI to a log while executing program f on a packet. Furthermore, suppose that during one execution of the program, the program returns path p₁ and that the recorded execution log consists of a single entry indicating that f tested whether the value of the TCP destination port of the packet was 22 and that the result of the test was affirmative. One can then infer that if the program is again given an arbitrary packet with TCP destination port 22, the program will choose path p₁ again. To take advantage of this observation, the controller in some embodiments may collect the traces and outcomes for these executions into a data structure known as a “trace tree”, which forms an abstract model of the algorithmic policy. FIG. 5 depicts a trace tree formed after collecting the traces and outcomes from six executions of f, including the aforementioned trace and outcome. For example, one further execution in this example consists of the program first testing TCP destination port for 22 and finding the result to be false, reading the Ethernet destination field to have a value of 4, then reading the Ethernet source to have value 6, and finally returning a value indicating that the packet should be dropped. This trace and outcome is reflected in the rightmost path from the root of the trace tree in FIG. 5. In this example, the right child of a “Test” node models the behavior of a program after finding that the value of a particular packet attribute is not equal to a particular value.

In some embodiments, a trace tree may provide an abstract, partial representation of an SDN program. The trace tree may abstract away certain details of how f arrives at its decisions, but may still retain the decisions as well as the decision dependency of f on the input. In order to describe the trace tree and related techniques precisely, we briefly establish some notation. It is assumed that there is a finite set of packet attributes Attrs={a₁, . . . aₙ} and p.a is written for the value of the a attribute of packet p. domₐ is written for the set of values that attribute a can take on; e.g. p.aεdom(a) for any packet and any attribute a.

In some embodiments, a “trace tree (TT)” may be a rooted tree where each node t has a field typeₜ whose value is one of the symbols L, V, T or Ω and such that:
1. If typeₜ=L, then t has a valueₜ field, which ranges over possible return values of the algorithmic policy. This node models the behavior of a program that returns valueₜ without inspecting the packet further.
2. If typeₜ=V, then t has an attrₜ field with attrₜ εAttrs, and a subtreeₜ field, where subtreeₜ is a finite associative array such that subtreeₜ[v] is a trace tree for values vεdom(attrₜ). This node models the behavior of a program which reads packet attribute attrₜ and continues to behave as subtreeₜ[v] if V is the value of the attrₜ attribute of the input packet.
3. If typeₜ=T then t has an attrₜ field with attrₜ εAttrs, a valueₜ field, such that valueₜ εdom(attrₜ), and two subtrees t₊ and t₋. This node models the behavior of a program that tests whether the value of the attrₜ field of a packet is valueₜ and whose behavior is modelled by t₊ if the test is true, and t₋ otherwise.
4. If typeₜ=Ω then t has no fields. This node models arbitrary behavior, i.e. it represents a program about which there is no information.

In some embodiments, a trace tree may encode a partial function from packets to results. The exemplary “searchTT” algorithm, presented in FIG. 6, may be used in some embodiments for extracting the partial function encoded in the trace tree. This method accepts a trace tree and a packet as input and traverses the given trace tree, selecting subtrees to search as directed by the decision represented by each tree node and by the given packet, terminating at L nodes with a return value and terminating at Ω nodes with NIL.

A trace tree is referred to herein as “consistent with an algorithmic policy” f if and only if for every packet for which the function encoded by a trace tree returns an outcome, that outcome is identical to the outcome specified by f on the same packet.

In certain embodiments, a “dynamic modeler” component may be used to build a trace tree from individual traces and outcomes of executions of f. In some embodiments, the dynamic modeler may initialize the model of the algorithmic policy, f, with an empty tree, represented as Ω. After each invocation of f, a trace may be collected and the dynamic modeler may augment the trace tree with the new trace. Several methods of augmenting a trace tree are possible. In some embodiments, the augmentation method used may satisfy a requirement that the resulting trace tree must be consistent with the algorithmic policy f modeled by the trace tree, provided the input trace tree was consistent. More precisely: if a given trace tree is consistent with f and a trace is derived from f, then augmenting the trace tree with the given outcome and trace results in a new trace tree that is still consistent with f.

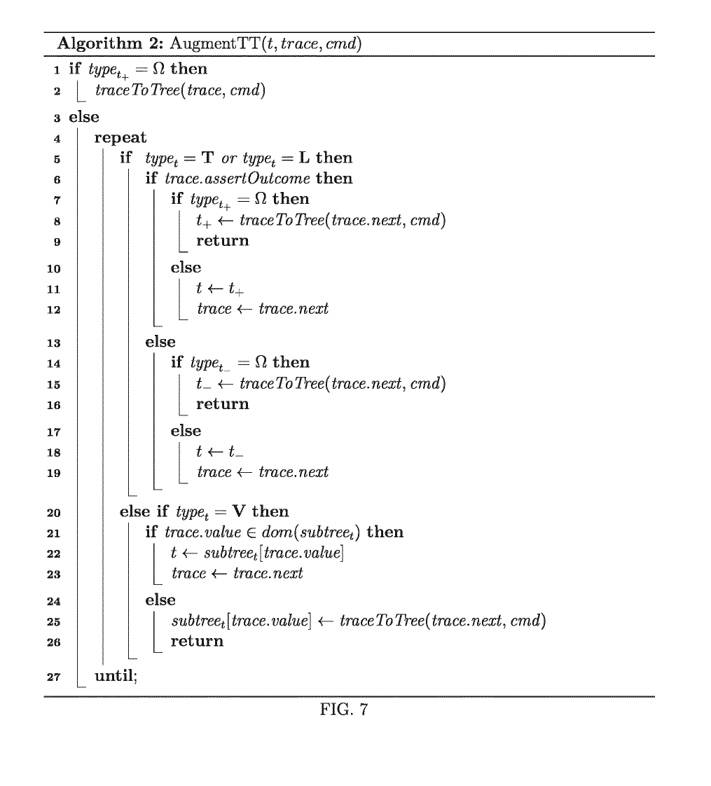

In certain embodiments, an exemplary algorithm referred to as “AugmentTT”, presented in FIG. 7, may be used to implement the trace tree augmentation. For concreteness, the exemplary algorithm assumes that a trace is a linked list and assumes the following notation. Suppose trace is a trace. If the first item in trace is a read action, then value is the value read for the read action. If the first item is a test action, then trace.assertOutcome is the Boolean value of the assertion on the packet provided to the function when the trace was recorded. Finally trace.next is the remaining trace following the first action in trace.

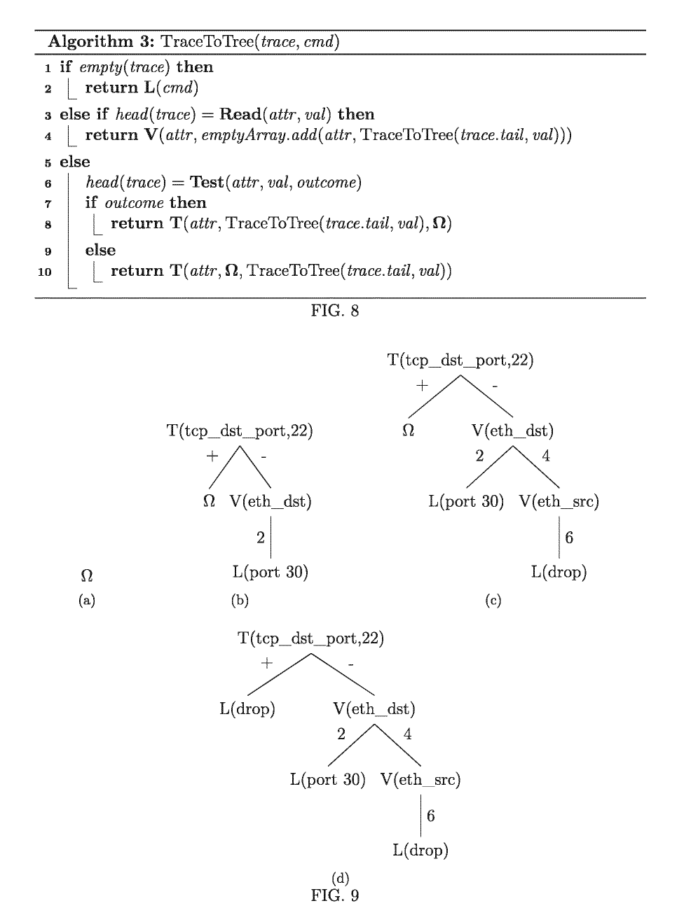

Exemplary algorithm AugmentTT adds a trace and outcome to the trace tree by starting at the root of tree and descending down the tree as guided by the trace, advancing through the trace each time it descends down the tree. For example, if the algorithm execution is currently at a V node and the trace indicates that the program reads value 22 for the field of the V node, then the algorithm will descend to the subnode of the current V node that is reached by following the branch labelled with 22. The algorithm stops descending in the tree when the trace would lead to a subnode that is Ω. In this case, it extends tree with the outcome and remaining part of trace at the location of the Ω node that was found; by “remaining part of the trace,” is meant the portion of the trace following the trace item that was reached while searching for the location at which to extend the tree; e.g., the remaining part of the trace is the value of trace.next in the algorithm when the algorithm reaches any of lines 2, 8, 15, or 25. In some embodiments, an exemplary algorithm referred to as “TraceToTree”, presented in FIG. 8, may be used to convert a trace and final result to a linear tree containing only the given trace and outcome.

FIG. 9 illustrates an example applying a process of augmenting an initially empty tree. The first tree is simply Ω. The second tree results from augmenting the first with an execution that returns value 30 and produced trace Test(tcp_dst_port, 22, False), Read(eth_dst, 2). The augmentation replaces the root Ω node with a T node, filling in the t− branch with the result of converting the remaining trace after the first item into a tree using TraceToTree, and filling in the t+ branch with Ω. The third tree results from augmenting the second tree with an execution that returns value drop and produced the trace Test(tcp_dst_port, 22, False), Read(eth_dst, 4), Read(eth_src, 6). In this case, AugmentTT extends the tree at the V node in the second tree. Finally, the fourth tree results from augmenting the third tree with an execution that returns drop and results in the trace Test(tcp_dst_port, 22, True).

In certain embodiments, the TAPI may not support assertions on packet attributes, and the traces may consist of only the reads of attribute values. In this case, the trace tree model may be modified to omit T nodes. The resulting model may have lower fidelity than the trace tree model and may not afford compilation algorithms that take full advantage of hardware resources available of network elements. However, it may be appropriate in certain applications, since it may be possible to implement this model with lower storage requirements in the controller.

In certain embodiments, the TAPI may include methods to read network attributes such as topology information and/or host locations, by which are meant the switch and port at which a host connects to the network. In this case, the traces and the trace tree model can be enhanced to include these as attributes and to thereby encode a partial function on pairs of packets and environments. In one example, in some embodiments the TAPI may include the following API calls:

readLocation::(Env, Host)->Loc

readHostPorts::(Env,SwitchID)->[PortID]

readTopology:: Env->Topology

readMinHopPath::(Env, Loc, Loc)->Path

Here, the notation [PortID] denotes a linked list of PortID values.

The detailed contents of the network state (e.g., the network attributes queried) and the API used to access it from an algorithmic policy may vary according specific embodiments of the invention. In one exemplary embodiment, the network attributes may include (1) the set of switches being controlled, (2) the network topology represented as a set of directed links, in the form of a set of ordered pairs of switch-port identifiers, (3) the location (in the form of a switch-port identifier) of hosts in the network via an associative array that associates some hosts with a specific location, (4) and traffic statistics for each switch-port, for example in the form of a finite sequence of time-stamped samples of traffic counters including number of bytes and number of packets transmitted and received. In this embodiment, the algorithmic policy can invoke API functions, such as the functions with the following type declarations:

Set<Link> links( );
Set<SwitchID> switches( );
Location hostLocation(Host h);

For example, topology information may be used for the computation of paths that packets should traverse. Various routing algorithms may be applied to a given topology, including shortest-path, equal-cost-shortest-paths, and/or widest-path routing.

Embodiments of the invention may vary in the technique(s) used to obtain such network state information. In one embodiment, the system may include an OpenFlow controller that issues requests for port statistics at randomized time intervals. In some embodiments, topology information (e.g., the set of links) may be determined by sending a “probe” packet (e.g., as an LLDP frame) on each active switch-port periodically. The probe packet may record the sender switch and port. Switches may be configured (e.g., via the control system) to forward probe packets to the controller in the form of packet-in messages. Upon receiving a probe packet, a switch may send the packet to the controller through a packet-in message which includes the receiving port. The controller may then observe the switch-port on which the probe was sent by decoding the probe frame and may determine the port on which the probe was received from the switch that generated the packet-in message and the incoming port noted in the packet-in message. These two switch-ports may then be inferred to be connected via a network link.

In other embodiments, network environment information may be provided by any suitable external component, given a suitable API to this external component. For example, the system could be applied to a network controlled by an OpenDaylight controller or a Floodlight controller, which may already include components to determine network topology and/or other information.

In some embodiments in which the policy depends on network state variables, the controller keeps the policy model as well as the rule sets in network elements up-to-date, so that stale policy decisions are not applied to packets after network state (e.g., topology) has changed. In some embodiments using the trace tree model, the model can be extended to explicitly record the dependencies of prior policy decisions on not only packet content but also on environment state such as network topology and/or configuration, providing information the controller may use to keep flow tables up-to-date. For example, the trace tree can be enhanced such that the attributes recorded at V and T nodes include network state attributes. When part of the network state changes, the controller may use its trace tree(s) to determine a subset of the distributed flow tables representing policy decisions that may be affected by state changes, and may invalidate the relevant flow table entries. It has been appreciated that it may be “safe” to invalidate more flow table entries than necessary, though doing so may impact performance. Some embodiments therefore may afford latitude with which to optimize the granularity at which to track environment state and manage consistency in the rule sets of network elements.

It has been recognized that merely caching prior policy decisions using trace trees may not make an SDN scalable if the controller still had to apply these decisions centrally to every packet. Real scalability may result when the controller is able to “push” many of these packet-level decisions out into the rule sets distributed throughout the OpenFlow-like network elements. Therefore, given the trace trees resulting from executing and analyzing policy executions, in some embodiments the dynamic optimizer may compute efficient rule sets for the network elements, and distribute these rules to the network elements.

Several methods of generating network element rule sets from trace trees are possible. Such methods are named trace tree compilation methods. In some embodiments, they may satisfy a requirement that if a packet is processed locally by a network element rule set—i.e., without consulting the controller—then the action performed on the packet is identical to the action recorded in the trace tree for the same packet.

The term “flow table” is used herein as a synonym for “rule set” and the abbreviation “FT” is used to refer to a flow table. In some embodiments, an FT may be a partial mapping from priority levels to sets of disjoint rules, where a rule consists of a (match, action) pair and two rules are disjoint when their match conditions are. The empty mapping is denoted as . The notation p→{r₁, . . . rₙ} is used to denote a partial map that maps priority p to the disjoint rule set {r₁, . . . , rₙ} and all other priorities to the empty set. The union of two flow tables ft₁ and ft₂, written ft₁/±Jft₂ is defined only when ft₁(p) and ft₂(p) are disjoint for all priorities p (two rules are disjoint when their match conditions are disjoint). In this case, the union is defined to map each priority p to the set ft₁(p)∪ft₂(p). This definition is extended to apply to several flow tables and is written/±J{ft₁, . . . , ftₙ} to denote the flow table ft₁/±J . . . /±Jftₙ. An action in a rule is either a port identifier or the distinguished symbol ToController which denotes an action that, when performed, forwards the packet to the controller.

In some embodiments, forwarding on the basis of a FT ft may be performed by finding the lowest priority entry that applies to a packet and performing the specified action. If no action is found, the packet may be forwarded to the controller. This is now formulated more precisely as follows. The set of all triples (p, m, a) such that p→{r₁, . . . , rₙ} is in FT and rᵢ=(m, a) for some i{1, . . . , n} is known as the “rule triples” in ft. A packet pkt is said to match in an FT ft at triple (p, m, a) in ft if m matches pkt as described earlier. A packet pkt is processed by FT ft with action a if there is a triple (p, m, a) in the rule triples of ft such that p is the least number among all numbers in the set {p′/(p′, m, a)εrule triples of ft} or if no such triple exists it is processed with action ToController.

Here the opposite numerical priority ordering as in OpenFlow protocols is followed, which select rules with numerically higher priority before those with numerically lower priority. However, embodiments are not limited in this respect, and in some embodiments the buildFT algorithm may assign priorities in numerically descending rather than ascending order.

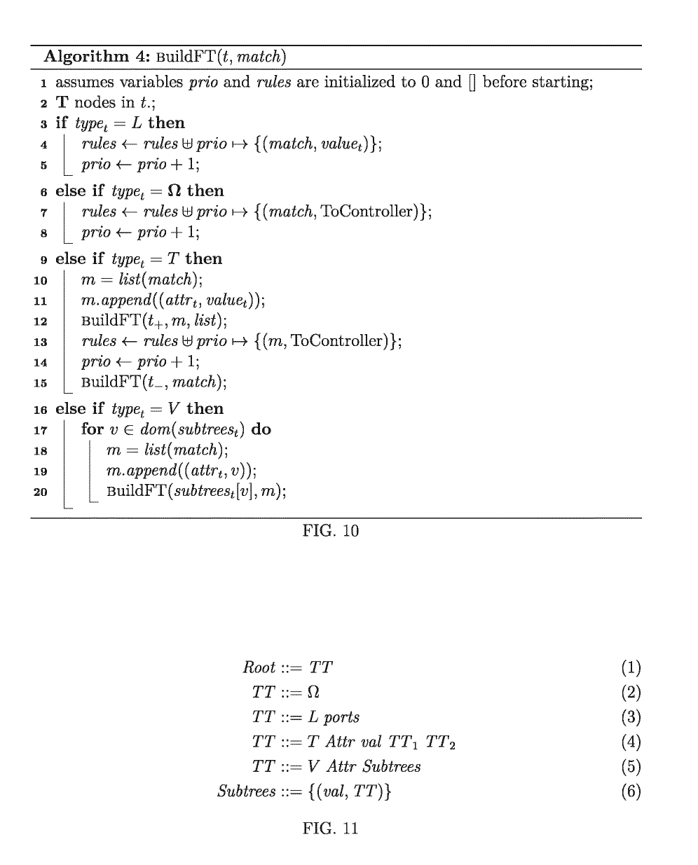

An exemplary buildFT algorithm is presented in FIG. 10. This example is a recursive algorithm that traverses the tree while accumulating a FT and maintaining a priority variable which is incremented whenever a rule is added to the FT. The variables holding the FT and priority are assumed to be initialized to and to 0, respectively, before beginning. The exemplary algorithm visits the leaves of the tree, ensuring that leaves from t₊ subtrees are visited before leaves from t₋ subtrees, adding a prio→{(match, action)} entry to the accumulating FT for each leaf. As the algorithm descends down the tree, it accumulates a match value which includes all the positive match conditions represented by the intermediate tree nodes along the path to a leaf Since negative matches are not supported directly in the match conditions, the exemplary algorithm ensures that any rule that may only apply when some negated conditions hold is preceded by other higher-priority rules that completely match the conditions that must be negated. Such rules (that ensure that lower priority rules only match when a condition is negated) are called “barrier rules”; they are inserted at line 13 of the exemplary algorithm. To begin the process, buildFT is applied to a tree t and an empty match value.

A beneficial property of the exemplary buildFT algorithm is that its asymptotic time complexity is O(n), where n is the size of the tree, since exactly one pass over the tree is used.

The operation of the buildFT algorithm is illustrated on an example. The algorithm buildFT is applied to the trace tree in the final trace of FIG. 9(d). The root of the tree is a T node, testing on TCP destination port 22. Therefore, the algorithm satisfies the condition in the if statement on line 9. Lines 10 and 11 then define a new match value m with the condition to match on TCP port 22 added. The algorithm then builds the table for the t₊ subnode in line 12 using the new match condition m. The t₊ branch is just a L node with drop action, therefore the resulting table will simply add a rule matching TCP port 22 with value drop to the end of the currently empty FT in line 4 and will increment the priority variable in line 5. The algorithm then returns to line 13 to add a barrier rule also matching TCP port 22, with action ToController and increments the priority variable in line 14. Then in line 15, the algorithm proceeds to build the table for the t₋ branch, with the original match conditions. The output for this example is the following FT:
{0→{(tcp_dst_port=22, drop)},
1→{(tcp_dst_port=22, ToController)},
2→{(eth_dst=2, port(30))},
3→{(eth_dst=4 ̂eth_src=6, drop}}.

As noted above, the exemplary buildFT algorithm cannot place a negated condition such as tcp_dst_port≠22 in rules. Instead, it places a barrier rule above those rules that require such negation. The barrier rule matches all packets to port 22 and sends them to the controller. In this example, the barrier rule is unnecessary, but in general the matches generated for the t₊ subtree may not match all packets satisfying the predicate at the T node, and hence a barrier rule may be used. Exemplary algorithm buildFT conservatively always places a barrier rule; however, further algorithms may remove such unnecessary rules, as described further below.

It has been recognized that the selection and prioritization of rules for rule sets can impact the hardware resources required at network elements, e.g. table space required to represent rule sets, and hence the amount of recent policy information a switch can cache. Therefore, in some embodiments the dynamic optimizer can incorporate methods to select rules in order to optimize resource usage in network elements. In particular, some embodiments provide techniques that can be used by a dynamic optimizer to minimize the number of rules used in rule sets through element-local and/or global optimizations. Alternatively or additionally, the number of priority levels used may be minimized, which may impact switch table update time. Previous studies have shown that update time is proportional to the number of priority levels. Examples of such techniques are now described.

Although buildFT is efficient and correct, it has been recognized that (1) it may generate more rules than necessary; and (2) it may use more priority levels than necessary. For example, consider the example buildFT compilation result discussed above. The barrier rule (the second rule) is not necessary in this case, since the first rule completely covers it. Moreover, observe that fewer priorities can be used; for example, the last two rules do not overlap and so there is no need to distinguish them with distinct priority levels. Combining these two observations, the following rule set would work to implement the same packet forwarding behavior:
{0→{(tcp_dst_port=22, drop)},
1→{(eth_dst=2, port(30))},
1→{(eth_dst=4 ̂eth_src=6, drop)}}.

Reducing the number of rules used may be beneficial, because rules are often implemented in Ternary Content Addressable Memory (TCAMs) (see K. Pagiamtzis and A. Sheikholeslami, “Content-addressable memory (CAM) circuits and architectures: A tutorial and survey,” IEEE Journal of Solid-State Circuits, vol. 41, no. 3, pp. 712-727, March 2006), and space available in TCAMs may be limited. Reducing the number of priority levels may be beneficial because the best algorithms for TCAM updates have time complexity O(P) where P is the number of priority levels needed for the rule set (D. Shah and P. Gupta, “Fast Updating Algorithms for TCAMs”, IEEE Micro, January 2001, 21, 1, 36-47). Therefore, it has been appreciated that reducing the number of priority levels can reduce the time required to perform rule set updates in network elements. Hence, certain embodiments include methods of generating rule sets that minimize the number of rules and/or priorities used and which can be used in place of buildFT.

The exemplary optBuildFT algorithm is specified using the attribute grammar formalism, introduced in D. E. Knuth, “Semantics of Context-Free Languages”, Mathematical Systems Theory, 2, 2, 1968, 127-145 (and further described in Paakki, J, “Attribute grammar paradigms—a high-level methodology in language implementation”, ACM Comput. Surv, June 1995, 27, 2, 196-255), a formalism frequently used to describe complex compilation algorithms. Each of the foregoing references is incorporated herein by reference in its entirety. In this formalism, a trace tree is viewed as an element of a context-free grammar, a collection of variables associated with elements of the grammar is specified, and the equations that each variable of a grammar element must satisfy in terms of variables of parent and children nodes of the node to which a variable belongs are specified. Further details of the attribute grammar formalism can be found in the literature describing attribute grammars.

Some embodiments may apply this formalism by defining the trace trees with a context-free grammar. FIG. 11 specifies exemplary production rules for a context-free grammar for trace trees. This example leaves some non-terminals, e.g. Attr unspecified, as these are straightforward and their precise definition does not fundamentally alter the method being described.

Some embodiments may then introduce additional quantities at each node in the trace tree, such that these quantities provide information to detect when rules are unnecessary and when new priority levels are needed. In particular, for each node node in the tree or at the root, some embodiments may calculate the following exemplary quantities:

node.comp Synthesized Boolean-valued attribute indicating that the node matches all packets, i.e. it is a complete function.

node.empty Synthesized Boolean-valued attribute indicating that the node matches no packets, i.e. it is equivalent to Ω.

node.mpu Synthesized integer-valued attribute indicating the maximum priority level used by node.

node.mch Inherited attribute consisting of the collection of positive match conditions which all packets matching in the subtree must satisfy.

node.ft The forwarding table calculated for the node. The value of this variable at the root of the trace tree is the overall compilation result.

node.pc Inherited attribute consisting of the priority constraints that the node must satisfy. The priority constraints are a list of pairs consisting of (1) a condition that occurs negated in some part of the tree and (2) the priority level such that all priorities equal to or greater are guaranteed to match only if the negation of the condition holds.

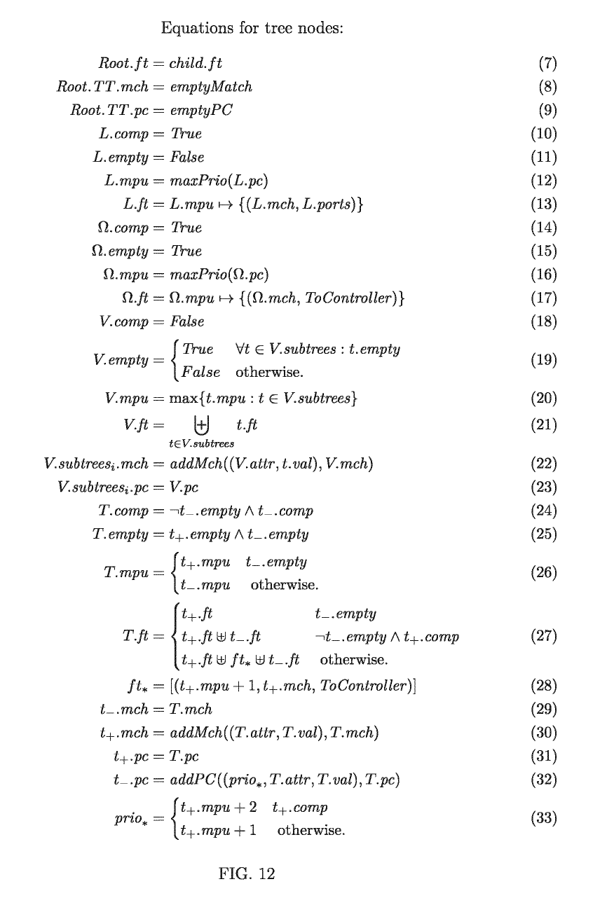

FIG. 12 lists exemplary equations that may be used in some embodiments for the variables at each node in terms of the variables at the immediate parent or children of the node. For example, Equation 27 states that a barrier rule is only needed in a T node if both the positive subtree (t₊) is incomplete and the negated subtree (t₋) is not empty. This equation eliminates the unnecessary barrier in our running example, since in our example the positive subtree completely matches packets to tcp port 22.

The exemplary equations in FIG. 12 make use of three auxiliary functions, whose straight-forward definitions are omitted, since a skilled practitioner can easily provide implementations of them. In particular, maxPrio(pc) returns the maximum priority included in a set of priority constraints pc. addMch((a, v), m) appends a field condition specified by attribute a and value v to a match m. addPC ((p, a, v), pc) adds a priority constraint specified by priority p, attribute a, and value v to priority constraint pc.

Priority constraint (pc) variables: The (pc) variable at each node contains the context of negated conditions under which the rule is assumed to be operating. Along with each negated condition, it includes the priority level after which the negation is enforced (e.g. by a barrier rule). The context of negated conditions is determined from the top of the tree downward. In particular, the pc values of the T and V subtrees are identical to their parent node values, with the exception of the t₋ subtree, which includes the negated condition in the parent node. In this way, only T nodes increase the number of priority levels required to implement the flow table. In particular, V nodes do not add to the pc of their subtrees.

Finally, the pc value is used in the L and Ω nodes which take the maximum value of the priority levels for all negated conditions which overlap its positive matches. This is safe, since the priority levels of disjoint conditions are irrelevant. It is also the minimal ordering constraint since any overlapping rules must be given distinct priorities.

The exemplary compilation algorithm just specified may allow the compiler to achieve optimal rule sets for algorithmic policies performing longest IP prefix matching, an important special case of algorithmic policy. This is demonstrated with the following example. Consider an algorithmic policy that tests membership of the IP destination of the packet in a set of prefixes and that it tests them in the order from longest prefix to shortest. Suppose the set of prefixes and output actions are as follows:

103.23.3/24-->a

103.23/16-->b

101.1/16-->c

101.20/13-->d

100/9-->e

Although the tests nodes add priority constraints for each prefix, the final leaf nodes remove constraints due to disjoint prefixes. This allows the compiler to achieve the optimal priority assignment:

0, 103. 23. 3/24-->a

0, 101. 1/16-->c

1, 103. 23/16-->b

1, 101. 20/13-->d

1, 100/9-->e

The solutions to the equations listed in FIG. 12 for any particular trace tree can be algorithms. Some exemplary embodiments may utilize a solver (i.e. an algorithm for determining the solution to any instance of these equations) for this attribute grammar using a functional programming language with lazy graph reduction. In some embodiments, the solver may compute values for all variables with a single pass over the trace trace, using a combination of top-down and bottom-up tree evaluation and the time complexity of the algorithm is therefore linear in the size of the trace tree.

In certain embodiments, the algorithmic policy may depend on some database or other source of information which the controller has no knowledge of. In other words, the database may be maintained by some external entity. For example, the forwarding policy that should be applied to packets sent by a particular endpoint may depend on the organizational status of the user who is operating the endpoint; for example, in a campus network, the forwarding behavior may depend on whether the user is a registered student, a guest, or a faculty member. Other external data sources may include real clock time.

When the algorithmic policy depends on external state, in some embodiments the program f written by the user may represent a function of the following form:

f::(Packet, Env, State)->ForwardingPath

In this example, f takes as inputs a packet header, an environment parameter that contains information about the state of the network, including the current network topology, the location of hosts in the network, etc. and a user-defined state component that provides f with external sources of information relevant to determining the forwarding policy.

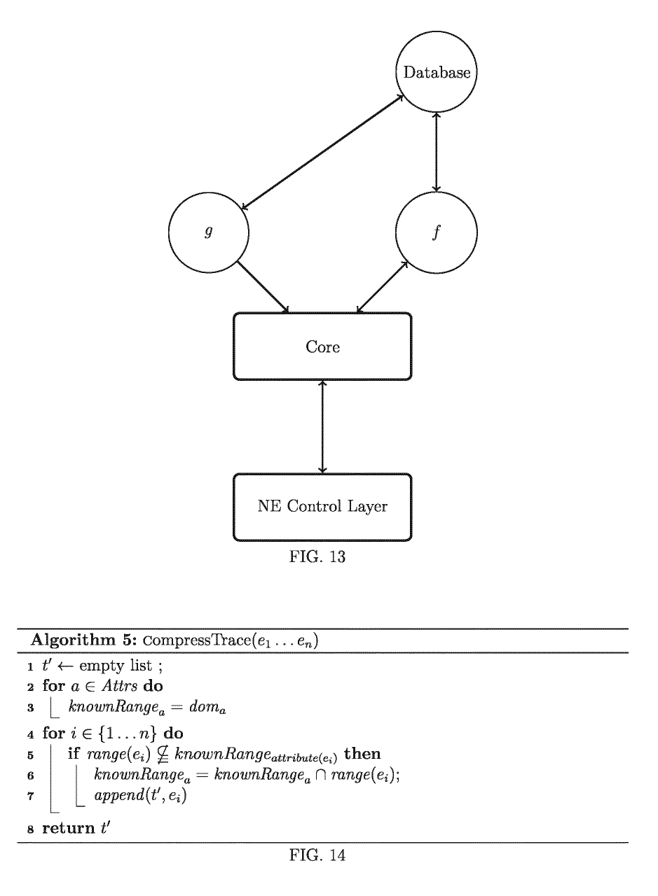

In some embodiments in which the policy uses an external database, an indication may be made to the system that a change to the external state has occurred and to indicate the particular subset of the inputs to the policy on which the policy may make decisions differently as a result of this changed external state. FIG. 13 depicts an exemplary arrangement of components in accordance with one or more embodiments, wherein the user-defined algorithmic policy depends on external sources of information. FIG. 13 depicts a database component and indicates that both the algorithmic policy (f) and an invalidator component (g) communicate with the database. The invalidator component may be an arbitrary program, running independently of the core, that notifies the core that the output of the algorithmic policy may have changed for some particular portion of inputs. The invalidation messages may take different forms and meanings in various embodiments. In some embodiments, the invalidation message indicates invalidation criteria that identify which execution traces should be invalidated. In one embodiment, the system may receive invalidations which identify a subset of packets based on their packet attributes using match conditions, and which identify executions which could have received packets in the given subset of packets. In another embodiment, the invalidation message may indicate a prefix of an execution trace such that recorded execution traces that extend the specified execution trace prefix should be invalidated.

In some embodiments, when an invalidation command is received, the system may immediately remove recorded executions that satisfy the invalidation criteria and update the forwarding element configurations to be consistent with the updated set of recorded executions.

In some embodiments, where the user-defined algorithmic policy requires access to state components other than those included in the system-provided environment component, the algorithmic policy TAPI may be enhanced with to allocate state components, in the form of instances of various mutable data structures that can be updated by user-defined program logic at runtime. These data structures may include, e.g., variables, finite sets, and/or finite associative arrays. In such embodiments, the TAPI may permit the policy to read and update state components using data-structure-specific operations, such as read and write for variables, membership test, insert and/or delete for sets, and/or key membership, key-based value lookup, insert and/or delete in associative arrays.

In some embodiments in which the TAPI is enhanced with mutable data structures, the tracing runtime may be enhanced to automatically invalidate recorded executions which become invalid due to changes in the instances of mutable data structures used in a user-defined algorithmic policy. In some embodiments, the tracing runtime may be enhanced to trace operations on mutable data structure instances. The tracing runtime may build a data structure referred to herein as a “dependency table”, that records, for each state component, the currently recorded executions that accessed the current value of that state component. In some embodiments, the system may intercept state-changing operations on program state components and automatically invalidate any prior recorded executions which depended on the state components changed in the operation.

In some embodiments, the TAPI may ensure that the effects of state-changing operations performed by user-defined algorithmic policies upon application to certain packets occur, even when rules are generated for such executions. In some embodiments, the system may avoid installation of forwarding rules that would prevent the execution of the controller-located algorithmic policy on specific packets, if executing the policy on those packets would change some state components. Thus, in some embodiments, the tracing runtime may be enhanced to detect when executions are idempotent on a class of packets and in a given state, where an execution is idempotent on a class of packets in a given state if executing it again in the given state on any packet in the class of packets would not change the given state. An algorithm which performs this task in the tracing runtime is referred to herein as the “idempotent execution detection algorithm.”

In some embodiments, the tracing runtime system may delay update of the forwarding element configurations after an update to state components that invalidates some prior recorded executions, and may instead apply a technique referred to herein as “proactive repair”. Using proactive repair, in some embodiments the system may enhance the recorded execution, by additionally recording the packet used to generate the execution. When an update to state components occurs, the dependency table may be used to locate the recorded executions that may be invalidated. These identified executions may be removed from the set of recorded executions. The system may then reevaluate the user-defined algorithmic policy on the packets associated with the identified executions to be invalidated. Each reevaluated execution which does not change system state may then be recorded as a new execution. Finally, the system may execute commands on the forwarding elements in order to update their forwarding configurations to be consistent with the resulting recorded executions after both removing the invalidated executions and recording the non-state changing reevaluated executions.

In some embodiments using the “proactive repair” technique, when a state changing event occurs, the system may apply a rule update minimization algorithm to compute the minimal update required to update the forwarding element configurations from their current state to their final state after proactive repair. For example, suppose the system is in state with flow tables F. When a state change occurs, invalidation of recorded executions and proactive repair may produce a sequence of flow table updates U₁, . . . , Uₙ,U₁′, . . . , Uₘ′ where Uᵢ are changes due to removal of non-cacheable traces from the trace tree and Uⱼ′ are changes due to the addition of newly cacheable traces resulting from proactive repair. The final result of applying these state changes may be a new collection of flow tables F′. In the case where most flows are unaffected, F′ may be very similar to F, even though there may be many changes contained in U₁, . . . , Uₙ,U₁′, . . . , Uₘ′. It has been recognized that naively executing each of these flow table changes to move the system to flow tables F′ may become a substantial bottleneck, since currently available hardware OpenFlow switches process fewer than 1000 flow table updates per second (see Charalampos Rotsos, Nadi Sarrar, Steve Uhlig, Rob Sherwood, and Andrew W. Moore. OFLOPS: An Open Framework for OpenFlow Switch Evaluation. In Proceedings of the 13th International Conference on Passive and Active Measurement, PAM '12, pages 85-95, Berlin, Heidelberg, 2012. Springer-Verlag.)

Rather than actually apply all the changes specified by the updates, in some embodiments the system using update repair may apply a technique referred to herein as update minimization to execute the minimum number of updates required to move update flow tables from F to F′. For example, let F consist of rules rᵢ=(pᵢ,mᵢ,aᵢ), for iεI where pᵢ is rule priority, mᵢ is the rule match condition, aᵢ is the rule action. Similarly, let F′ be rⱼ′=(pⱼ′,mⱼ′,aⱼ′), for jεJ.

Then the minimal collection of updates may be as follows:

Delete rᵢ, when [symbol] ∃j:pᵢ=pⱼ′ [symbol] mᵢ=mⱼ

Insert rⱼ, when [symbol] ∃i:pᵢ=pⱼ′ [symbol] [symbol] mᵢ=mⱼ′

Modify rᵢ to action aⱼ′, when ∃j: pᵢ=pⱼ′ [symbol] mᵢ=mⱼ′ [symbol] not (aᵢ=aⱼ′)

This can be seen to be a minimal update since any updates that result in a rule with a priority and match that were not used in F′ must accomplish this through at least one insert. Likewise, a rule in F such that no rule in F′ has the same priority and match must have been removed through at least one deletion. Rules with same priority and match but different action require at least one modification or at least one deletion and one insertion.

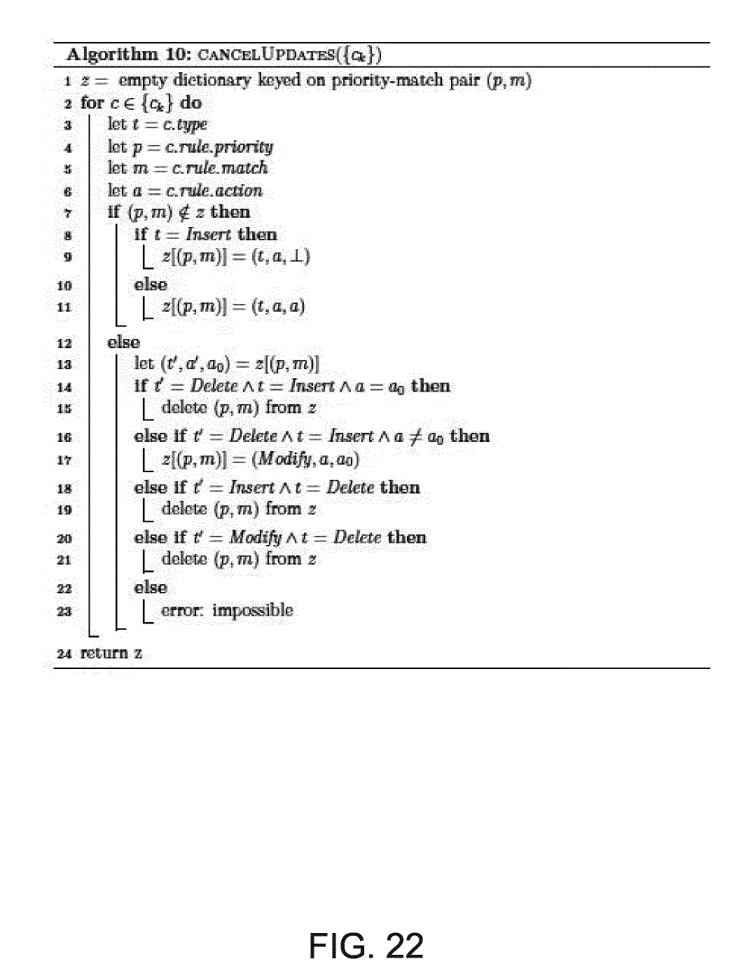

In some embodiments, the update minimization can be achieved using the exemplary cancelUpdates algorithm, shown in FIG. 22. This exemplary algorithm calculates the above minimum update using a linear O(Sum|Uᵢ|+Sum|Uⱼ′|) time. To specify the algorithm, some notation is first defined. Each update Uᵢ and Uⱼ′ consists of a sequence of changes where each change has two components: c.type, which is one of the update type constants Insert, Delete, Modify, and c.rule which is an OpenFlow rule. Note that the updates produced by the trace tree operations (remove trace and augment) generate a sequence of inserts and deletions (i.e. no modifications) with no consecutive inserts (or deletes) of rules with the same priority and match. {c₁, . . . , cₖ} is to be the sequence that results from concatenating the changes of U₁, . . . , Uₙ, U₁′, . . . , Uₘ′ in order. The cancelUpdates algorithm computes a dictionary, z, mapping pairs (p, m) of priority p and match m to a triple (t, a, a0) where t is the update type, a is the action to use in the final modify or update command and a0 is the action that the rule had in the initial rule set F in the case that there was a rule with priority p and match m in F. The only rules that need to be updated are the ones with entries in z. The algorithm makes a single pass over {c₁, . . . , cₖ} in order. For each (p, m), it processes alternating insertions and deletions (if no rule with (p, m) is in F) or alternating deletions and insertions (if a rule with (p,m) is in F). If the algorithm encounters a change with (p,m) not in z, then it adds the change to z. In addition, if the type is Delete, then a rule existing in F is being deleted (since, given the meaning of z, no change has been made to a (p, m) rule yet), so the action is the action of the rule in F and the algorithm saves the action in the triple added to z. Otherwise, the algorithm has already saved a change to the rule with (p, m) and it updates the change as appropriate. For example, if c inserts a rule that was previously deleted and the inserted rule has an action that differs from the initial action in F, then the algorithm applies a modification. On the other hand, if the inserted rule has the same action as the initial action in F, the algorithm removes the change, since no changes need to be made to F in this case. The other cases follow from similar reasoning.

Although the number of distinct observations that a program f can make of the packet header may be finite, a program may repeatedly observe or test the same attribute (field) of the packet header, for example during a loop. This can result in a large trace. Therefore, certain embodiments may use a technique for reducing the length of traces produced from executions of an algorithmic policy by the tracing runtime system. For example, some embodiments may utilize a method referred to as “CompressTrace” which eliminates both read and test redundancy. This exemplary method implements the following mathematical specification. Consider a non-reduced trace t consisting of entries e₁ . . . eₙ. For any trace entry e accessing information about attribute a let range(e) denote the set of values for attribute a consistent with e. For example, if e consists of a false assertion that the tcp destination port attribute equals 22, then range(e) is the set of all tcp port values, except for 22. Further define
knownRangeₐ(0)=dom(a), for all attributes a
knownRangeₐ(i+1)=knownRangeₐ(i) ∩ range(eᵢ+1), for all attributes a and iε{1 . . . n−1}.

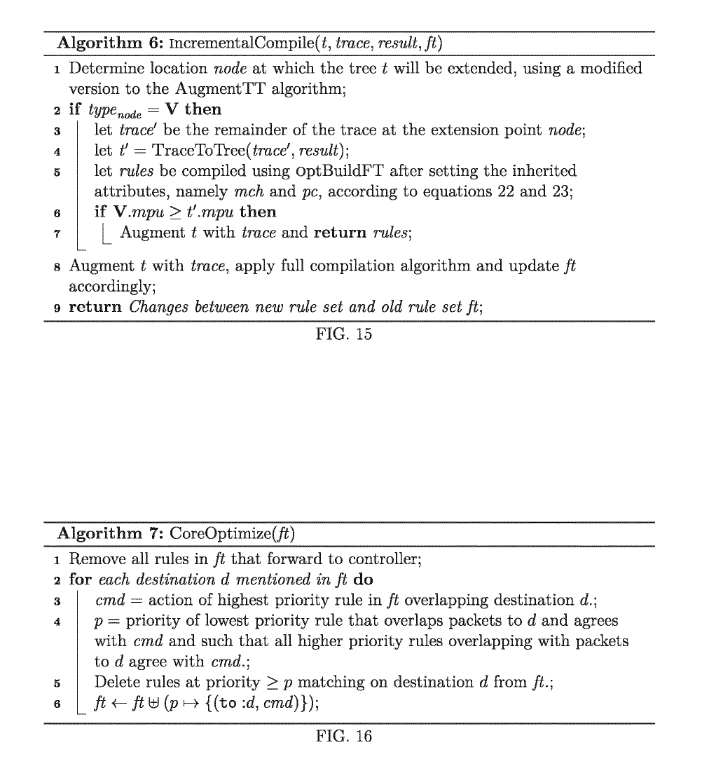

Finally, define the reduced trace t′ to be the subsequence of t such that if knownRangeₐ(i+1)=knownRangeₐ(i) for all attributes a, then eᵢ-1 is not a member of t′. The exemplary algorithm CompressTrace, presented in FIG. 14, may be used in some embodiments to compute a reduced trace according to this specification. Those skilled in the art should readily appreciate how this algorithm can be adapted to run as the trace log is gathered, rather than after the fact.

As used herein, an “incremental algorithm” is an algorithm that maintains a correspondence between one data structure, the “target”, in correspondence with another data structure, the “source”, when the source undergoes a sequence of changes, such that the change in the target is calculated from the change to the source. This informal notion of an incremental algorithm can be stated more precisely as follows. Let S and T be “source” and “target” sets respectively and h:S→T be a function from S to T known as the “correspondence”. S_{Δ} is a subset of the set of functions S→S known as the “delta” set. An incremental algorithm for source S, target T, correspondence h and source changes S_{Δ} consists of an algorithm that (given appropriate representations of each of the input sets and functions) implements a function w:(S×S_{Δ}×T)→T such that for any s₀εS and sequence δ₀ . . . δₙ₋₁. of elements of S_{Δ}, one has tᵢ=h(sᵢ) for all iε{0, 1, . . . n} where t₀=h(s₀), sᵢ₊₁=δᵢ(sᵢ) and tᵢ₊₁=w(sᵢ,δᵢ,tᵢ),

Certain embodiments may use incremental algorithms to calculate rule set updates from model updates. More precisely, in some embodiments the source set may be the set of (some variant of) trace trees, the target set may include the collection of rule sets of network elements, the delta set may include pairs of traces and outcomes, and the correspondence may be (some variant of) a compilation function from trace trees to rule sets. Various embodiments may use different incremental algorithms, including, in some embodiments, incremental algorithms that maintain the same relationship between the rule set and the trace tree as the OptBuildFT algorithm.

In one embodiment, the incremental algorithm presented in FIG. 15 may be used. This exemplary algorithm avoids recompilation in the case that a trace augments the trace tree at a V node and the mpu variable of the V node is unchanged by the augmentation. In this case, the only modification of the rule set is the addition of a small number of rules, directly related to the trace being inserted, and no other rules are altered. In this case, the method may simply update the rule set with the new rules needed for this trace. It is possible to devise more sophisticated incremental algorithms that perform localized updates in more general cases.

Any of the aforementioned methods of determining rule sets from policy models (including those based on trace tree models) may use the same process to produce a forwarding table for each switch. However, switches in a network are connected in a particular topology and a packet traversing switches is processed by a particular sequence of switches which essentially form a pipeline of packet processing stages. Some embodiments may take advantage of this extra structure to substantially optimize the rule tables in the network by dynamically partitioning the packet processing responsibilities among different switches.

This insight is applied to the following problem. The flow tables generated in some embodiments may be required to implement two functions: (1) forward flows whose route is known and (2) pass packets which will pass through unknown parts of the trace tree back to the controller. In some embodiments, the packet processing feature can be partitioned among the switches by ensuring that function (2) is enforced on the first hop of every path, i.e. at edge ports in the network. If this is maintained, then forwarding tables at internal switches may only implement function (1).

Certain embodiments may take advantage of this insight by using the “CoreOptimize” algorithm in the dynamic optimizer. This exemplary algorithm, presented in FIG. 16, reduces the size of rule sets at many network elements. The algorithm may be applied to the core rule set of a network element, by which is meant the subset of the rule set of a network element that applies to packets arriving on ports which interconnect the network element with other network elements (as opposed to connecting the network element with endpoints). The exemplary algorithm first removes all rules forwarding to the controller. It then attempts to encompass as many rules as possible with a broad rule that matches based on destination only. It has been recognized that the deletion of rules that forward to controller may allow for agreement to be found among overlapping rules.

It is appreciated that the aforementioned exemplary algorithm may not alter the forwarding behavior of the network because the only packets that may be treated differently are those which are forwarded to the controller at an edge port in the network by virtue of the rule sets generated by correct compilation algorithms not using the CoreOptimize algorithm. Therefore, such packets may never reach a network element where it is processed by a core network rule without being sent to the controller first, thus achieving desired behavior.

This exemplary algorithm optimizes for the common case that forwarding of packets is based primarily on the destination. It has been appreciated that this is likely to be important in core switches in the network, which must process many flows and where rule space is a more critical resource. It has been appreciated further that the exemplary algorithm has the advantage that this table compression may be implemented automatically, and applies just as well to shortest path routing as to other routing schemes. In fact, it may apply well even when there are exceptions to the rule for various destinations, since even in that case it may be possible to cover many rules, up to some priority level.

The exemplary algorithm can be implemented efficiently. Each of the steps in the CoreOptimize algorithm can be performed in O(|n|) time where n is the number of rules in the rule set provided as input to the algorithm.

The algorithms described herein were implemented, and example networks were evaluated with various algorithmic policies using techniques described herein. The TAPI, the dynamic modeler and optimizer of the control protocol layer, was implemented entirely in Haskell, a high-level functional programming language with strong support for concurrency and parallelism. The implemented control protocol layer includes a complete implementation of the OpenFlow 1.0 specification (the specification is available at http://www.openflow.org/documents/openflow-spec-v1.0.0.pdf).

The evaluation OpenFlow controllers were run on an 80 core SuperMicro server, with 8 Intel Xeon E7-8850 2.00 GHz processors, each having 10 cores with a 24 MB smart cache and 32 MB L3 cache. Four 10 Gbps Intel network interface controllers (NICs) were used. The server software includes Linux Kernel version 3.7.1 and Intel ixgbe drivers (version 3.9.17). Both real network elements as well as an OpenFlow network simulator based on cbench (http://www.openflow.org/wk/index.php/Oflops), a well-known benchmarking program for OpenFlow controllers, were used.

To evaluate the optimizer, cbench was extended with a simple implementation of a switch flow table, using code from the OpenFlow reference implementation. cbench was modified to install rules in response to flow modification commands from controllers, to forward packets from simulated hosts based on its flow tables. The program was instituted to collect statistics on the number of flow table misses and flow table size over time.

The optimizer was evaluated with three HP 5406zl switches implementing the OpenFlow 1.0 protocol. These switches were placed in a simple linear topology with no cycles.

Multiple algorithmic policies have been implemented. Evaluations focused on the layer 2 learning controller. The layer 2 (“L2”) learning controller is an approximation (in the context of OpenFlow) of a traditional Ethernet using switches which each use the Ethernet learning switch algorithm. In such a controller each switch is controlled independently. Locations for hosts are learned by observing packets arriving at the switch and forwarding rules are installed in switches when the locations of both source and destination for a packet are known by the controller from the learning process. Using this controller allows us to compare both optimizer techniques as well as runtime system performance in comparison with other available controller frameworks, all of which include an equivalent of a layer 2 learning controller implementation.

For the simulated optimizer evaluations, cbench was modified to generate traffic according to key statistical traffic parameters, such as flow arrival rate per switch, aver-age flow duration, number of hosts per switch and distribution of flows over hosts and applications.

Two experiments were performed to evaluate the optimizer. In the first experiment, the packet miss rate was measured, which is the probability that a packet arriving at a switch fails to match in the switch's flow table. This metric strongly affects latency experienced by flows in the network, since such packets incur a round trip to the controller.

Two controllers were compared, both implementing layer 2 learning. The first controller, which we refer to as “Exact”, is written as a typical naive Openflow controller using exact match rules and built with the Openflow protocol library used by the overall system. The second controller, which is referred to as “AlgPolicyController” is written as an algorithmic policy and uses the optimizer with incremental rule updates to generate switch rules.

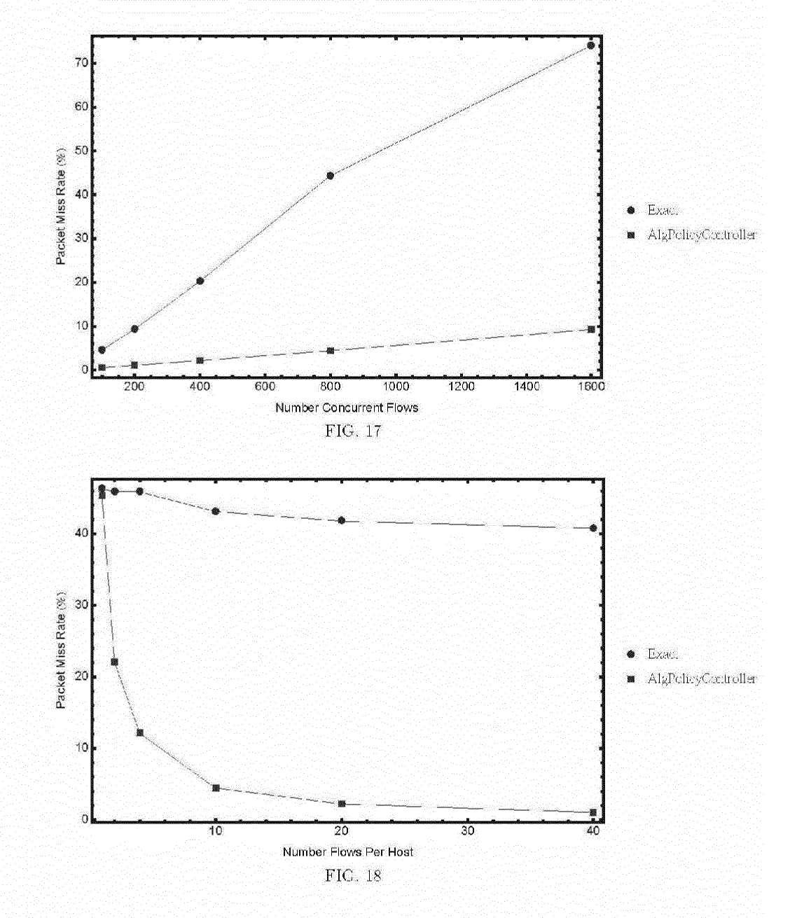

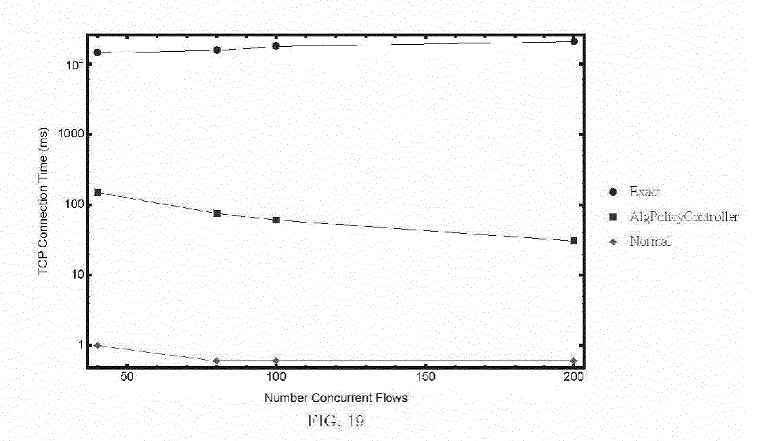

FIG. 17 compares the packet miss rate as a function of the number of concurrent flows at a switch. The measurement was taken using the extended cbench with an average of 10 flows per host, 1 second average flow duration and 1600 packets generated per second. In both cases, the miss rate increases as the number of concurrent flows increases, since the generated packets are increasingly split across more flows. However, the AlgPolicyController dramatically outperforms the hand-written exact match controller. In particular, the AlgPolicyController automatically computes wildcard rules that match only on incoming port and source and destination fields. The system therefore covers the same packet space with fewer rules and incur fewer cache misses as new flows start. FIG. 18 compares the packet miss rate as a function of the number of concurrent flows per host. Again, the algorithmic policy substantially outperforms the exact match controller.

In the second experiment, time to establish a number of TCP connections between hosts on either end of a line of 3 HP 5406 Openflow switches was measured. The measurement was performed using httperf (Mosberger, D and Jin, T., “httperf a tool for measuring web server performance”, SIGMETRICS Perform. Eval. Rev., December 1998, 26, 3, pp. 31-37). Essentially the same two controllers as before were used, except that they were modified to use only IP matching fields in order to accommodate the switches' restrictions on which flows can be placed in hardware tables. In this case, learning and routing was performed based on IP addresses, and an exact match was interpreted as being exact on IP fields.

For comparison, the same metric when used with the ordinary L2 function of the switches was also measured. FIG. 19 shows the mean connection time as a function of the number of concurrent connections initiated, with the y-axis on a log scale. The average connection time for the exact match controller is roughly 10 seconds, 100 times as long as with AlgPolicyController. The native L2 functionality performs much better, with average connection time around 0.5 ms, indicating the overheads associated with OpenFlow on this line of switches. The surprisingly slow connection time in this evaluation highlights how the need to configure a sequence of switches on a path (3 in this case) dramatically decreases performance, and underscores the importance of reducing the number of misses in the flow tables as networks scale up.

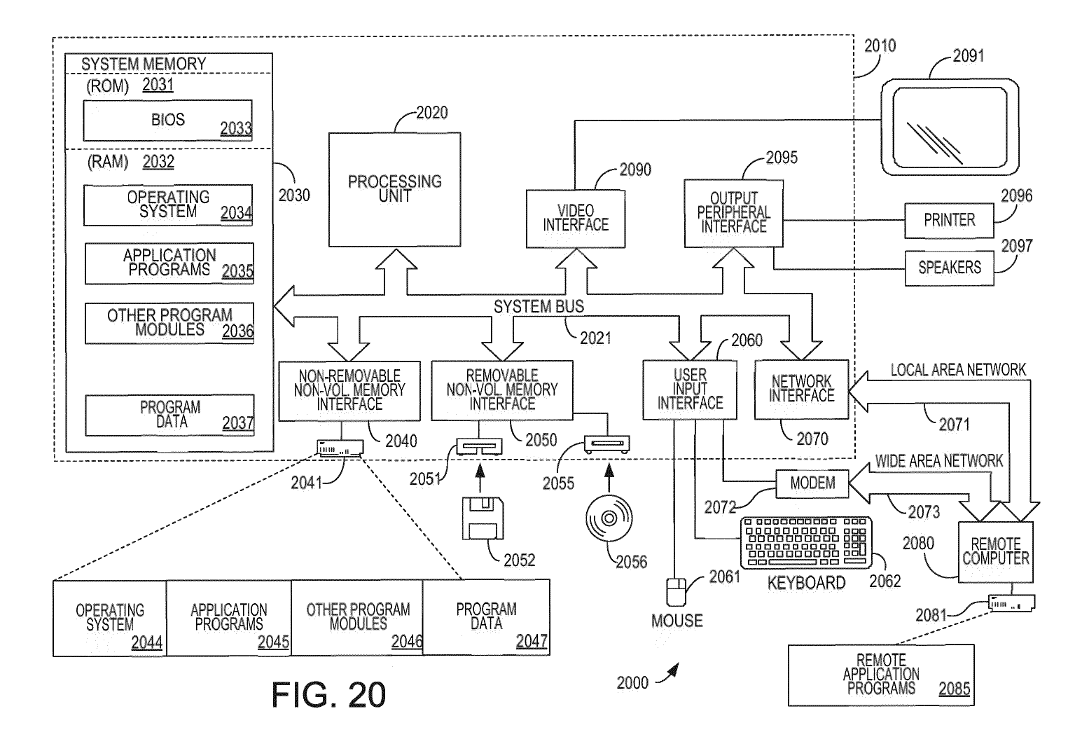

FIG. 20 illustrates an example of a suitable computing system environment 2000 in which some embodiments may be implemented. This computing system may be representative of a computing system that allows a suitable control system to implement the described techniques. However, it should be appreciated that the computing system environment 2000 is only one example of a suitable computing environment and is not intended to suggest any limitation as to the scope of use or functionality of the described embodiments. Neither should the computing environment 2000 be interpreted as having any dependency or requirement relating to any one or combination of components illustrated in the exemplary operating environment 2000.

The embodiments are operational with numerous other general purpose or special purpose computing system environments or configurations. Examples of well-known computing systems, environments, and/or configurations that may be suitable for use with the described techniques include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc., that perform particular tasks or implement particular abstract data types. The embodiments may also be practiced in distributed computing environments where tasks are performed by remote processing devices that are linked through a communications network. In a distributed computing environment, program modules may be located in both local and remote computer storage media including memory storage devices.

With reference to FIG. 20, an exemplary system for implementing the described techniques includes a general purpose computing device in the form of a computer 2010. Components of computer 210 may include, but are not limited to, a processing unit 2020, a system memory 2030, and a system bus 2021 that couples various system components including the system memory to the processing unit 2020. The system bus 2021 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 2010 typically includes a variety of computer readable media. Computer readable media can be any available media that can be accessed by computer 2010 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 2010. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 2030 includes computer storage media in the form of volatile and/or nonvolatile memory such as read only memory (ROM) 2031 and random access memory (RAM) 2032. A basic input/output system 2033 (BIOS), containing the basic routines that help to transfer information between elements within computer 2010, such as during start-up, is typically stored in ROM 2031. RAM 2032 typically contains data and/or program modules that are immediately accessible to and/or presently being operated on by processing unit 2020. By way of example, and not limitation, FIG. 20 illustrates operating system 2034, application programs 2035, other program modules 2036, and program data 2037.

The computer 2010 may also include other removable/non-removable, volatile/nonvolatile computer storage media. By way of example only, FIG. 20 illustrates a hard disk drive 2041 that reads from or writes to non-removable, nonvolatile magnetic media, a magnetic disk drive 2051 that reads from or writes to a removable, nonvolatile magnetic disk 2052, and an optical disk drive 2055 that reads from or writes to a removable, nonvolatile optical disk 2056 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 2041 is typically connected to the system bus 2021 through a non-removable memory interface such as interface 2040, and magnetic disk drive 2051 and optical disk drive 2055 are typically connected to the system bus 2021 by a removable memory interface, such as interface 2050.

The drives and their associated computer storage media discussed above and illustrated in FIG. 20 provide storage of computer readable instructions, data structures, program modules and other data for the computer 2010. In FIG. 20, for example, hard disk drive 2041 is illustrated as storing operating system 2044, application programs 2045, other program modules 2046, and program data 2047. Note that these components can either be the same as or different from operating system 2034, application programs 2035, other program modules 2036, and program data 2037. Operating system 2044, application programs 2045, other program modules 2046, and program data 2047 are given different numbers here to illustrate that, at a minimum, they are different copies. A user may enter commands and information into the computer 2010 through input devices such as a keyboard 2062 and pointing device 2061, commonly referred to as a mouse, trackball or touch pad. Other input devices (not shown) may include a microphone, joystick, game pad, satellite dish, scanner, touchscreen, or the like. These and other input devices are often connected to the processing unit 2020 through a user input interface 2060 that is coupled to the system bus, but may be connected by other interface and bus structures, such as a parallel port, game port or a universal serial bus (USB). A monitor 2091 or other type of display device is also connected to the system bus 2021 via an interface, such as a video interface 2090. In addition to the monitor, computers may also include other peripheral output devices such as speakers 2097 and printer 2096, which may be connected through an output peripheral interface 2095.

The computer 2010 may operate in a networked environment using logical connections to one or more remote computers, such as a remote computer 2080. The remote computer 2080 may be a personal computer, a server, a router, a network PC, a peer device or other common network node, and typically includes many or all of the elements described above relative to the computer 2010, although only a memory storage device 2081 has been illustrated in FIG. 20. The logical connections depicted in FIG. 20 include a local area network (LAN) 2071 and a wide area network (WAN) 2073, but may also include other networks. Such networking environments are commonplace in offices, enterprise-wide computer networks, intranets and the Internet.

When used in a LAN networking environment, the computer 2010 is connected to the LAN 2071 through a network interface or adapter 2070. When used in a WAN networking environment, the computer 2010 typically includes a modem 2072 or other means for establishing communications over the WAN 2073, such as the Internet. The modem 2072, which may be internal or external, may be connected to the system bus 2021 via the user input interface 2060, or other appropriate mechanism. In a networked environment, program modules depicted relative to the computer 2010, or portions thereof, may be stored in the remote memory storage device. By way of example, and not limitation, FIG. 20 illustrates remote application programs 2085 as residing on memory device 2081. It will be appreciated that the network connections shown are exemplary and other means of establishing a communications link between the computers may be used.

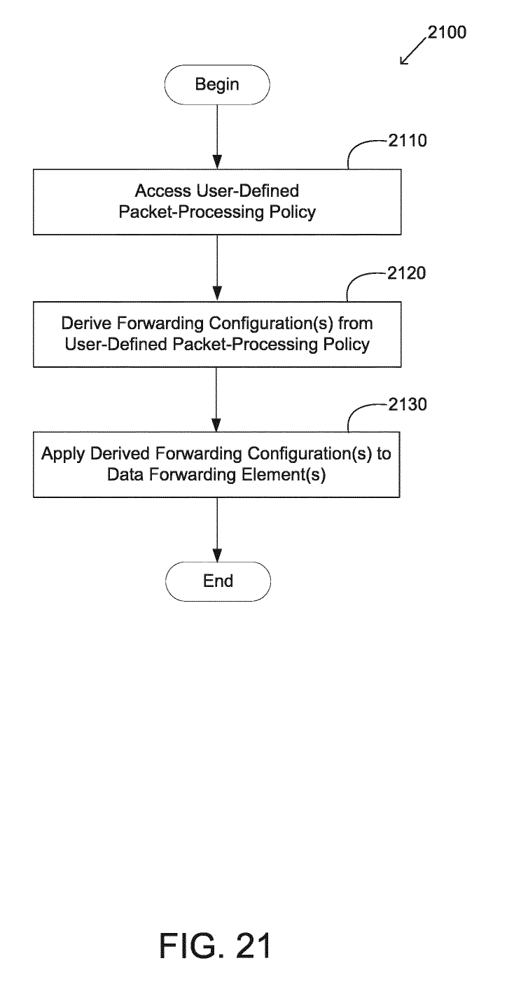

It should be appreciated from the foregoing that one embodiment is directed to a method 2100 for managing forwarding configurations in a data communications network including data forwarding elements each having a set of forwarding configurations and being configured to forward data packets according to the set of forwarding configurations, as illustrated in FIG. 21. Method 2100 may be performed, for example, by one or more components of a control system for the data communications network, such as one or more controllers, which may be implemented in some embodiments as one or more control servers. Method 2100 begins at act 2110, at which a user-defined packet-processing policy may be accessed at the controller. The packet-processing policy may be defined by the user in a general-purpose programming language, and may specify how data packets are to be processed through the data communications network via the at least one controller. As discussed above, in some embodiments the packet-processing policy may be an algorithmic policy.

At act 2120, one or more forwarding configurations for one or more data forwarding elements in the data communications network may be derived from the user-defined packet-processing policy. This may be done using any suitable technique(s); examples of suitable techniques are discussed above. In some embodiments, deriving the forwarding configuration(s) may include deriving one or more forwarding rules for the data forwarding element(s). As discussed above, a forwarding rule may specify one or more characteristics of data packets to which the forwarding rule applies (e.g., a match condition), and may specify how the data forwarding element is to process data packets having those characteristics (e.g., an action). In some cases, a data packet characteristic used as a match condition may include one or more specified packet attribute values. An action in a forwarding rule may specify any form of processing that can be performed on a data packet by a data forwarding element, such as specifying one or more ports of the data forwarding element via which the data packet is to be forwarded, specifying that the data packet is to be dropped, specifying that the data packet is to be processed by the controller, specifying modifications to be made to the data packet (e.g., rewriting header fields, adding new fields, etc.), etc. It should be appreciated, however, that forwarding configurations are not limited to forwarding rules, and other types of forwarding configurations for data forwarding elements may alternatively or additionally be derived, such as configurations for packet queues, scheduling parameters, etc.

In some embodiments, deriving the forwarding configuration(s) from the user-defined packet-processing policy may include static analysis of the user-defined packet-processing policy, such as by analyzing the user-defined packet-processing policy using a compiler configured to translate code from the general-purpose programming language of the user-defined packet-processing policy to the programming language of the data forwarding element forwarding rules.

Alternatively or additionally, in some embodiments dynamic (e.g., runtime) analysis (e.g., modeling) may be used to derive the forwarding configuration(s) from the user-defined packet-processing policy. For example, in some embodiments, deriving the forwarding configuration(s) may include applying the user-defined packet-processing policy at the controller to process a data packet through the data communications network. One or more characteristics of the data packet that are queried by the controller in applying the user-defined packet-processing policy to process the packet may be recorded, as well as the manner in which the data packet is processed by the user-defined packet-processing policy (e.g., the function outcome, which in some cases may be a path via which the data packet is routed through the data communications network). As discussed above, any suitable characteristics of the data packet may be queried under the policy and therefore recorded, such as one or more attribute values of the data packet that are read, one or more Boolean-valued attributes of the data packet that are tested, one or more network attributes such as network topology and/or host location attributes, etc. In some embodiments, this trace may allow a forwarding configuration to be defined to specify that data packets having the same characteristics that were queried in the first data packet are to be processed in the same manner.

In some embodiments, runtime analysis such as the tracing runtime may be complemented by and enhanced through static (i.e., compile-time) analysis, optimization and/or transformation. As an example, some embodiments may include a “useless packet access” elimination analysis. For example, consider the following algorithmic policy written in Java:

```
Route f(Packet p, Environment e) {
  int useless = p.ethType( );
  return nullRoute;
}
```

This program accesses the ethType field of the input packets, but unconditionally drops the packets (by sending them along the so-called “nullRoute”). This program is actually equivalent to the following program, which no longer accesses the ethType field:

Route f(Packet p, Environment e) {
return nullRoute;
}

In some embodiments, a useless code data-flow analysis may be performed on the source code of the algorithmic policy, and may eliminate accesses such as the p.ethType( ) access in the aforementioned program. At compilation time, the program may be transformed to an intermediate representation, such as a Static Single Assignment (SSA) form. In some embodiments, a data-flow analysis may then proceed in two phases. First, the analysis may add each statement exiting the program to a “work list”. The analysis may then repeatedly perform the following until the “work list” is empty: remove a statement from the “work list”, mark it as “critical” and add any statements that define values used in the given statement (identifiable since the program is in SSA form) to the “work list”. After this phase is over, eliminate any statements from the program that are not marked as “critical”.

Various other static analyses are possible that could be used to enhance the runtime to improve the quality of the rules and/or other forwarding configurations generated by the runtime and/or to improve the speed (efficiency) of the runtime itself. Some static analysis may allow the user-defined policy program to be partially pre-compiled, for example by completely expanding some portion of the trace trees.

In other embodiments, static analysis may be employed without operation of the tracing runtime, for some or all user programs. For example, in some embodiments, the control system may perform a static analysis on the input program by constructing a control flow graph of the program, in which each statement of the program is a node in the graph and the graph includes a directed edge from one node to a second node if the statement for the first node can be followed by the statement for the second node. Define the predecessors of a node to be all the nodes reachable by traversing edges in the backwards direction starting from a node. In one exemplary embodiment, the static analysis may assign to each node the set of packet attributes accessed in executing the statement for the node. Furthermore, each node may be assigned the set of the union of the packet attributes accessed in the statement of the node as well as the packet attributes accessed in all predecessors of the node. Finally, this exemplary static analysis may calculate the “accessed attribute set” for the overall program to be the union of the packet attributes accessed from each node representing a return statement from the function.

In some static analysis embodiments such as the embodiment described above, no tracing runtime may be performed during execution of the algorithmic policy. In some exemplary embodiments, a memo table which associates keys with routes may be constructed. After executing the program on a given packet and obtaining a given result, an entry may be added to the memo table. The entry may include a vector of values consisting of the values of each attribute in the accessed attribute set on the given packet, in association with the given return value from the execution. Forwarding configurations such as OpenFlow flow rules may then be constructed for the memo table matching on only the accessed attribute set and using only a single priority level. In the case when all control flow paths through the input program access the same set of packet attributes, this method may compute a memo table which is essentially identical to the trace tree which would be produced by the tracing runtime system for this program. However, omitting the tracing runtime may improve performance in some embodiments, by avoiding the runtime overhead associating with runtime tracing.

In some embodiments of the invention, the algorithmic policy programming model (i.e. the algorithmic policy programming language, including the TAPI) is enhanced with data structures which can be accessed and updated as part of the packet processing function (“updateable data structures”). In some embodiments, these data structures include variables, which hold a value of some specific type, finite sets, which contain a finite number of elements of some type, and finite maps, which contain a finite number of key-value pairs of some key and value types where there is at most one entry for a given key. Each of these data types is polymorphic and can be instantiated at various types. The programming model can be extended to provide commands to read from and write to variables, to insert and delete elements from sets and to query whether an element is a member of a set, and to insert and delete entries into maps and to lookup a value for a given entry in a map, if it exists.

In some embodiments of the invention which extend the packet processing programming model with updateable data structures (as described above), the system may provide a so-called “Northbound APT” which allows external programs to query and update the state of the network control system. The Northbound API may consist of data-structure updating commands which can be executed by sending appropriately encoded messages to a communication endpoint provided by the network control system. In some embodiments, this communication endpoint can be an HTTP server accepting commands encoded in JSON objects or XML documents. In some embodiments of the invention the north-bound API can be derived automatically from the collection of data structures declared by the user-defined algorithmic policy.

In embodiments of the invention which extend the packet processing programming model with updateable data structures (as described above) and a north-bound API permitting external programs to update the state of the program, the north-bound API may allow multiple update commands to be grouped and executed as a “transaction” with appropriate atomicity, consistency, isolation, durability (ACID) guarantees.

In embodiments of the invention which extend the packet processing programming model with commands to update declared state components in response to the receiving of a packet, the runtime system must be enhanced to correctly support these operations. In particular, a mechanism must be provided to avoid caching recorded execution traces and generating corresponding forwarding configurations for packets which, if the packet processing function were applied to them, would cause some state components to be updated. These state updates which failed to occur because packets were forwarded by network elements and not sent to the network controller are called “lost updates”.

In some embodiments of the invention which extend the packet processing programming model with state-changing commands, the runtime system avoids lost updates by enhancing the tracing execution algorithm to detect when state updates are performed during an execution of the algorithmic policy. If any updates are performed, the execution is not recorded and no flow table entries are added to the forwarding tables of network elements. With this method, rules are only installed on forwarding elements if the execution which generated them did not perform any state updates. Therefore, installed forwarding rules do not cause lost updates.

The aforementioned extension to the tracing runtime system to avoid lost updates is suboptimal because it prevents many executions from being recorded which would not lead to lost updates. For example, recording and generating rules for an execution which sets a Boolean variable to True without reading the value of the given Boolean variable will not lead to any lost updates, since if the program were executed on a packet of the same class again, the execution would perform no further state updates. In some embodiments of the invention, the tracing runtime system can be improved by using the following “read-write-interference” detection method. In this method, reads and updates to state components are recorded during tracing. Finally, if there exists a read of a state component prior to an update of that state component and that state component at the end of the execution has a value different from the value of that state component at the beginning of the execution, then the algorithm concludes that read-write interference occurred. Otherwise, the algorithm infers that no read-write interference occurred. If read-write interference occurs, the trace execution is not recorded and rules are not generated. This read-write-interference detection permits many more executions, including the example described above in this paragraph to be determined to be safe to cache. In addition, the tracing runtime system must record any components written to in the previously mentioned state dependency table, so that when a given a state component is updated to a new value, all previously recorded executions that change the given state component are invalidated. This is important to avoid lost updates, since a cached execution may lead to lost updates once the value of one of the components that it writes to has changed.

Embodiments of the invention permitting the algorithmic policy to update state components from the algorithmic policy packet processing function f enable the algorithmic policy system to efficiently implement applications where control decisions are derived from state determined by the sequence of packet arrivals. In particular, it enables efficient implementation of network controllers that maintain a mapping of host to network location which is updated by packet arrivals from particular hosts. A second application is Network Address Translation (NAT) service, which allows certain (so called “trusted hosts”) hosts to create state (i.e. sessions) simply by sending certain packets (e.g. by initiating TCP sessions). The packet processing function f for NAT would use a state component to record active sessions as follows. When a packet p arrives to the network, f performs a lookup in the state component to determine whether a session already exists between the sender and receiver (hosts). If so, the packet is forwarded. If no session exists for this pair of hosts and if the sender is not trusted, then the packet is dropped. If the sender is trusted, then a new session is recorded in the state component for this pair of hosts, and the packet is forwarded.

A third application is to so-called “server load balancing”. In this application, the network should distribute incoming packets to a given “virtual server address” among several actual servers. There exists a variety of methods for distributing packets among the actual servers. One possible method is to distribute packets to servers based on the sender address. For example, all packets from host 1 sent to the virtual server address can be sent to one actual server, while all packets from host 2 sent to the virtual server address can be sent to a second (distinct) actual server; however, all packets from a single host must be sent to the same actual server. Furthermore, the assignment of hosts to servers could be performed using a “round-robin” algorithm: the first host to send a packet to the virtual server address is assigned to actual server 1 and all packets from this host to the virtual server address are sent to actual server 1. The second host to send a packet to the virtual server address is assigned to actual server 2. This round-robin assignment is continued, using modular arithmetic to choose the server for each host. The algorithmic policy f that implements this round-robin server assignment will maintain a state component mapping from host to actual server address and a counter that is incremented on each distinct host that is detected. When a packet is received to the virtual server address, f performs a lookup in the state component to determine whether an actual server has been chosen for the sending host. If the lookup succeeds, the packet is forwarded to the actual server stored in the state component. Otherwise, the counter is read and the actual server is chosen by taking the remainder of the counter value after dividing by the number of actual servers available. Then the counter is incremented.

In some embodiments of the invention, the tracing runtime system records, along with an execution trace, the packet to which the packet processing function was applied in generating the execution trace. This copy of the packet may be used later to reduce the time required to update forwarding element configurations after state changes. In particular, after a state change occurs, either in state components maintained by the system (for example, network topology information and port status) or state components declared by the user-level algorithmic policy, several recorded executions may be invalidated. For each of these invalidated executions, the packet processing function may be immediately re-applied to the packet recorded for that execution, without waiting for such a packet to arrive at a forwarding element. Such executions are called “speculative executions”. Speculative executions can then be recorded and rules can be generated, as described above. Note that no packets are forwarded when performing a speculative execution; rather the execution serves only to determine what updated actions would be performed on the recorded packets, if they were to arrive in the network. Speculative execution can lead to reduced number of packets diverted to the network controller, since instead of removing invalid rules and waiting for arriving packets to trigger execution tracing, the system proactively installs updated and corrected rules, possibly before any packets arrive and fail to match in the forwarding table of network elements. When this method is applied in an embodiment that allows the packet processing function to issue state-updating commands, speculative executions should be aborted whenever such executions would result in observable state changes. The system simply abandons the execution and restores the values of updated state components in the case of speculative executions.

In some embodiments of the invention, the packet processing function can access data structures whose value at any point in time depends on the sequence of packet arrival, network, and configuration events that occur. For example, a particular user-defined packet processing function may desire to initially forward packets along the shortest path between any two nodes. Then, the user-defined policy only modifies the forwarding behavior when a previously used link is no longer available. (Existence of a link or a link's operational status can be determined by the state components maintained by the runtime system and made available to the algorithmic policy). This policy may result in non-shortest paths being used (since paths are not recalculated when new links become available). On the other hand, this policy ensures that routes are not changed, unless using the existing routes would lead to a loss of connectivity.

To support policies such as the aforementioned policy (in which forwarding state depends on the precise sequence of events), some embodiments of the invention extend the algorithmic policy programming model with a method to register procedures which are to be executed on the occurrence of certain events. These events include the policy initialization event, and may include events corresponding to changes to system-maintained state component, such as a port configuration change event, topology change, or host location change. In some embodiments, the algorithmic policy can register procedures to be executed after the expiration of a timer.

In some embodiments, the algorithmic policy language is extended with constructs for the creation of new packet and byte counters (collectively called “flow counters”) and with imperative commands to increment flow counters which can be issued from within the packet processing function f of an algorithmic policy. Using these constructs, the packet function may increment flow counters whenever a packet of a certain class (identified by a computation based on packet attributes accessed via the TAPI) is received. These flow counters may be made available to the algorithmic policy either by the network controller counting received bytes and packets, or by the network controller generating forwarding configurations for network elements such that the necessary byte and packet counters are incremented by some network elements which can be queried to obtain counts or can be configured to notify the network controller appropriately. In any case, flow counters may be made available to the user program in two forms. In the first form, the user may sample flow counters at any time, either during invocation of a packet function or not. As an example, the user program may include a procedure that is executed periodically (e.g. on a timer) and which may read the flow counters and take appropriate action depending on their values. In the second form, the user may register a procedure to be executed by the runtime system whenever a counter value is updated.

The following Java program illustrates the language extension with flow counters in a simple algorithmic policy. The following program declares two counters, “c1” and “c2”. In the constructor, a task to be executed periodically is established. This task simply prints the values of the two counters' bytes and packet count values. The program's packet processing function, defined in the “onPacket( )” method, increments the first counter for IP packets with source IP address equal to 10.0.0.1 or 10.0.0.2 and the second counter when the source IP address is 10.0.0.2.

import java.util.Timer;
import java.util.TimerTask;
import maple.core.*;
public class SP extends MapleFunction {
Counter c1 = newCounter( );
Counter c2 = newCounter( );
Timer timer;
public SP( ) {

final TimerTask task = new TimerTask( ) {

```
  @Override
  public void run( ) {
```

```
System.out.println(“c1: “ + c1.packets( ) + ”; ”
  + c1.bytes( ) + “ c2: “ + c2.packets( ) + ”; ”
  + c2.bytes( ));
```

}

};
Timer timer = new Timer( );
timer.scheduleAtFixedRate(task, 5000, 5000);

}
@Override
protected Route onPacket(Packet p) {
if (p.ipSrcIn(IPv4.toIPv4Address(“10.0.0.1”), 32)) {

c1.count( );

```
  }
  if(p.ipSrcIn(IPv4.toIPv4Address(“10.0.0.2”), 32))) {
```

c1.count( ); c2.count( );

```
  }
  SwitchPort dstLoc = hostLocation(p.ethDst( ));
  if (null == dstLoc) {
```

return Route.multicast(minSpanningTree( ), edgePorts( ));

```
  }
  return Route.unicast(dstLoc,
```

shortestPath(hostLocation(p.ethSrc( )), dstLoc));

}

}

In some embodiments, the policy runtime system makes use of the following method for distributed traffic flow counter collection. Counters may be maintained (incremented) by the individual network elements. This method allows packets to be processed entirely by the forwarding plane, while still collecting flow counters. This paragraph describes an extension to the aforementioned tracing runtime system which makes use of OpenFlow forwarding plane flow rule counters to implement flow counters used in algorithmic policies. In particular, an OpenFlow network element maintains packet and byte counters for each flow rule, called flow rule counters. When a packet arrives at a switch and is processed by a particular flow rule, the packet counter for the flow rule is incremented by one, and the byte counter is incremented by the size of the given packet. The extension to the tracing runtime system is as follows. First, each execution trace recorded in the trace tree is identified with a unique “flow identifier”, which is a fixed-width (i.e. 32 or 64 bit value). Second, each distinct flow counter is assigned a unique “counter identifier”. The tracing runtime system maintains a mapping, called the “flow_to_counter” mapping, which associates each flow identifier with a set of counter identifiers. For each flow identifier in the key set of the flow_to_counter mapping, the associated counter identifiers are precisely those counters that are incremented when receiving packets that would result in the same execution trace as that associated with the execution trace identified by the given flow identifier. The runtime system includes another mapping, called the “counter_values” which records the count of packets and bytes received for a given counter (identified by counter identifier). Third, on each execution of the user's algorithmic policy on an input packet, the tracing runtime records the identifiers of each counter that are incremented during the execution. Fourth, when flow rules are compiled for installation in OpenFlow switches for recorded execution traces, the rules for an execution trace at the ingress switch and port of the flow include the flow identifier in the “cookie” field of the OpenFlow rule. Fifth, the controller samples the byte and packet counters associated with flow identifiers by requesting statistics counts at the ingress network element of a given flow. Upon receipt of a flow statistics response, the cookie value stored inside the response is used to associate the response with a specific flow, and the flow_to_counter mapping is consulted to find all the counter identifiers associated with the given flow identifier. The values in the counter_values mapping for each associated counter identifier are incremented by the changed amounts of the input flow counters.

The aforementioned extension permits algorithmic policies to implement efficient distributed collection of flow statistics, since flow statistics for a given traffic class are measured at many ingress points in the network and then aggregated in the network controller. This technique allows algorithmic policies to efficiently implement several significant further network applications. One application is for network and flow analytics, which uses flow counters to provide insight and user reports on network and application conditions. A second application is for network and server load balancers that make load balancing decisions based on actual traffic volume. A third application is in WAN (Wide-area network) quality of service and traffic engineering. In this WAN application, the algorithmic policy uses flow counters to detect the bandwidth available to application TCP flows (a key aspect of quality of service) and selects WAN links depending on the current measured available link bandwidth.

In some embodiments of the invention, the algorithmic policy programming language is extended to provide access to “port counters”, including bytes and packets received, transmitted, and dropped on each switch port. These counters can be made available to the application program in a number of ways, including (1) by allowing the program to read the current values of port counters asynchronously (e.g. periodically) or (2) by allowing the program to register a procedure which the runtime system invokes whenever port counters are updated and which includes a parameter indicating the port counters which have changed and the amounts of the changes.

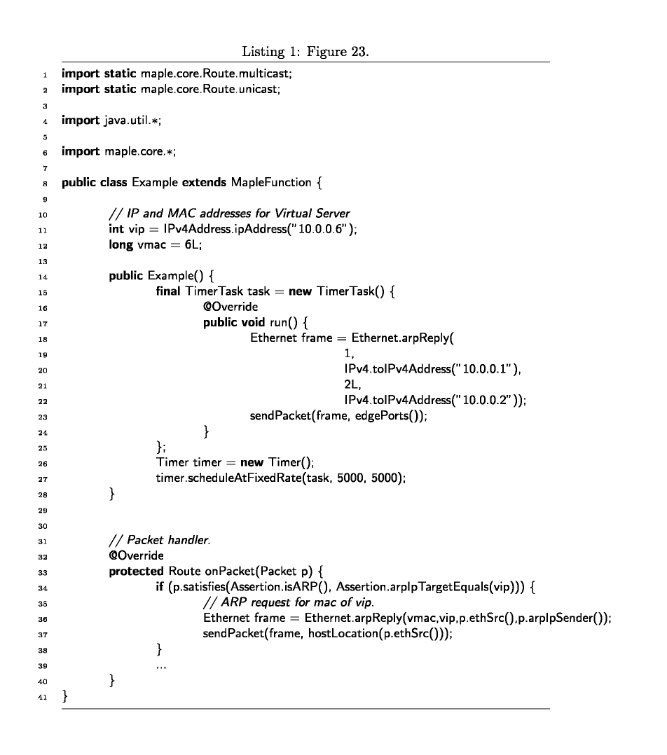

In some embodiments of the invention, the algorithmic policy programming language can be extended with commands to send arbitrary frames (e.g. Ethernet frames containing IP packets) to arbitrary ports in the network. These commands may be invoked either in response to received packets (i.e. within the packet processing function) or asynchronously (e.g. periodically in response to a timer expiration). FIG. 23 depicts a fragment of an example program in which the algorithmic policy programming language, implemented in Java, has been extended with a single command, “sendPacket(Ethernet frame)” which allows the program to send an Ethernet frame, where the Ethernet frame is modeled as a Java object of class “Ethernet”. In this example, the method is used to allow the network control system to reply to ARP (Address Resolution Protocol) queries. In addition, the example program installs a periodic task to send a particular IP packet every 5 seconds.

To support the sending of frames during execution of the packet processing function, the tracing runtime is enhanced to maintain a list of frames, called “frames_to_send”, that are requested to be sent by the execution. At the start of an execution this list is empty. When an execution of the packet processing function invokes a command to send a frame, the given frame is added to the frames_to_send list. After completion of the packet function execution, the frames in frames_to_send list are sent.

In embodiments in which the network elements do not support forwarding configurations which can specify actions to send particular packets, the runtime will avoid recording execution traces that include a non-empty list of frames_to_send and will not generate forwarding configurations to handle packets for these executions. This method avoids installing any forwarding configuration in forwarding elements that may forward packets that would induce the same execution trace. This is necessary to implement the intended semantics of the algorithmic policy programming model: the user's program should send frames on receipt of any packet in the given class of packets inducing the given execution trace, and installing rules for this class of traffic would not send these packets, since forwarding configurations of these network elements are not capable (by the assumption of this paragraph) of sending packets as one of their actions.

In embodiments in which network elements can be configured to respond to certain incoming packets with other packets, the runtime system may be enhanced to record such packet sending actions in the trace tree, and to generate forwarding rules which send particular packets on receipt of a given packet.

The aforementioned extension to send Ethernet frames, either in response to arrivals of packets in the network or in response to internally generated events (such as system timer expirations) enables the algorithmic policy method to be applied to several important network applications. In one application, the algorithmic policy language is used to implement an IP router. An IP router must be capable of sending frames, for example to respond to ARP queries for the L2 address corresponding to a gateway IP address, and to resolve the L2 address of devices on directly connected subnets. A second application enabled is a server load balancer which redirects packets directed to a virtual IP address (“VIP”) to one of a number of servers implementing a given network service. To do this, the load balancer must respond to ARP queries for the L2 address of the VIP. A third application is to monitor the health of particular devices by periodically sending packets which should elicit an expected response and then listening for responses to these queries. A fourth is to dynamically monitor link delay by sending ICMP packets on given links periodically. This can be used to monitor links which traverse complicated networks, such as WAN connections, which can vary in link quality due to external factors (e.g. the amount of traffic an Internet Service Provider (ISP) is carrying for other customers can cause variations in service quality).

In certain embodiments of the invention, the TAPI is extended with commands which retrieve packet contents that cannot be accessed by the forwarding hardware of the network elements. Such attributes are called “inaccessible packet attributes”. In particular, the TAPI can be extended with a command that retrieves the full packet contents. The tracing runtime system is then extended so that the result of an algorithmic policy execution is not compiled into forwarding configurations for network elements when the execution accesses such unmatchable packet attributes. The extension of the TAPI with commands to access the full packet payload enable new applications. In particular, it enables applications which intercept DNS queries and responses made by hosts in the network. This enables the algorithmic policy to record bindings between domain names and IP addresses, allowing network policies (e.g. security or quality of service policies) to be applied based on domain names, rather than only on network level addresses. A second application is to provide IP Address Management (IPAM) features, for example to implement DHCP services by accessing the payload of DHCP packets.

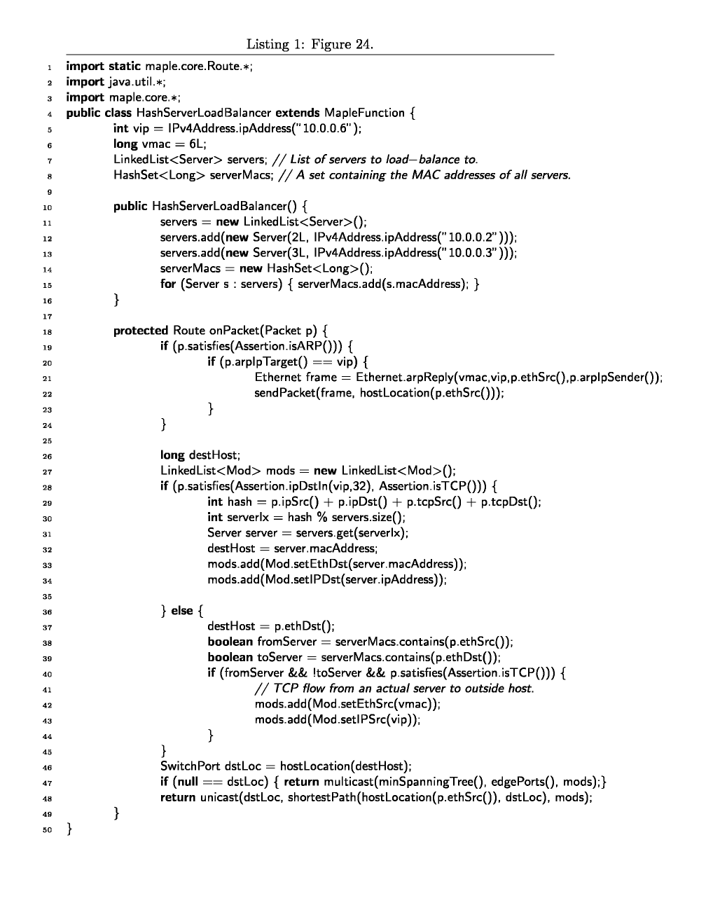

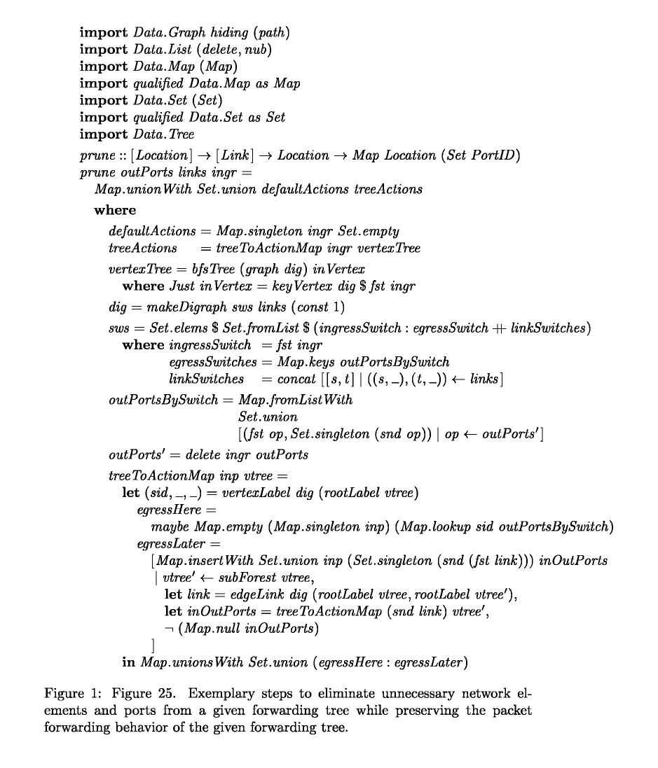

In certain embodiments of the invention the algorithmic policy programming language is extended with packet modification commands. These modification commands can perform actions such as setting L2, L3, and L4 fields, such as Ethernet source and destination addresses, add or remove VLAN tags, set IP source and destination addresses, set diffserv bits, and set source and destination UDP or TCP ports. In certain embodiments, these modifications are incorporated into the forwarding result returned by the algorithmic policy. FIG. 24 illustrates this approach to the integration of packet modifications into the algorithmic policy language. In this example code, the packet modifications are added as optional arguments to the “unicast” and “multicast” forwarding result values.

The aforementioned extension of the algorithmic policy programming model with packet modifications enables several important applications to be developed as algorithmic policies. In one application, IP forwarding is implemented as an algorithmic policy. This application requires packet modifications because an IP router rewrites the source and destination MAC addresses of a frame which it forwards. A second application is that of a server load balancer, which rewrites the destination MAC and IP addresses for packets addressed to the VIP and rewrites source MAC and IP addresses for packets from the VIP. A simple IP server load balancer written as an algorithmic policy is depicted in FIG. 24.

In some embodiments of the invention, the compiler generates forwarding configurations for network elements which perform the packet modifications directly in the forwarding plane of the network elements. In some embodiments, the compiler applies required packet modifications at the egress ports (i.e. ports on switches which lead to devices that are not switches managed by the controller) of the network. By applying modifications only at egress ports, the existing forwarding configuration compiler can be used to specify matching conditions, since in this embodiment packets traverse the entire network (up to the exit point) without being changed, and hence existing match conditions of rules will apply correctly. To handle the case in which an OpenFlow rule forwards a packet from a given switch to multiple ports, some of which are egress ports (i.e. do not lead to another switch controlled by the system) and some of which are non-egress ports (i.e. lead to another switch controlled by the system), the generated actions first send the packet to non-egress ports, then apply packet modifications, and then forward to egress ports.

In certain embodiments of the invention, the tracing runtime system prevents invalid routes from being installed. Invalid unicast routes consist of unicast routes which do not begin at the source location or which do not end at some egress location using a sequence of links where for every consecutive pair of links, the first link ends at the same switch that the second link begins at and such that no link reaches the same switch more than once. A multicast route is invalid if it consists of a collection of links which do not form acyclic directed graph. In these embodiments, the runtime system verifies validity of a returned result and returns a default route if the result is not valid.

In certain embodiments of the invention, the tracing runtime applies tree pruning to returned forwarding trees (including both unicast and multicast cases). A tree pruning algorithm returns a tree using a subset of links and egress ports specified in the input multicast action such that packets traversing the pruned tree reach the same egress ports as would packets traversing the original input tree. The resulting multicast tree returned from a tree pruning algorithm provides the same effective forwarding behavior, but may use fewer links and hence reduce network element processing requirements. FIG. 25 provides a specific tree pruning algorithm used in certain embodiments. This algorithm calculates a finite map in which each network location (switch and port pair) is mapped to a set of ports to which a packet should be forwarded to at that location. The entries of the map are minimal subset of the entries required which are sufficient so that every switch which can have a packet reach the switch in this forwarding behavior has a defined entry, and such that removing an entry from the map or removing any port from the set of ports associated with an entry would result in one or more desired egress locations not receiving a packet. The algorithm merges the default map which has a single entry associating the ingress location to no outgoing ports with a map of entries reachable from the ingress location. For entries with common keys, the resulting entry is associated with union of the port sets. The algorithm computes a breadth-first search tree of the input multicast tree links (by applying the “bfsTree” function). The algorithm then computes the ports to use at each switch by applying a recursive function applied to the breadth-first search tree. This algorithm computes a finite mapping specifying the outgoing ports to send a packet to from a given switch and incoming port. The outgoing ports to send a packet to at a given switch consist of those egress ports of the given route that are located on the given switch and all ports that lead to next hops in the breadth first search tree which have non-empty set of outgoing ports in the computed map. Since this latter quantity can be calculated by the algorithm being specified, the algorithm is a simple recursive algorithm. The time complexity of the algorithm is linear in the size of the inputs (links & list of egress locations). The resulting (pruned) route includes entries for only those switches and ports used on valid paths from the ingress port to the egress ports.

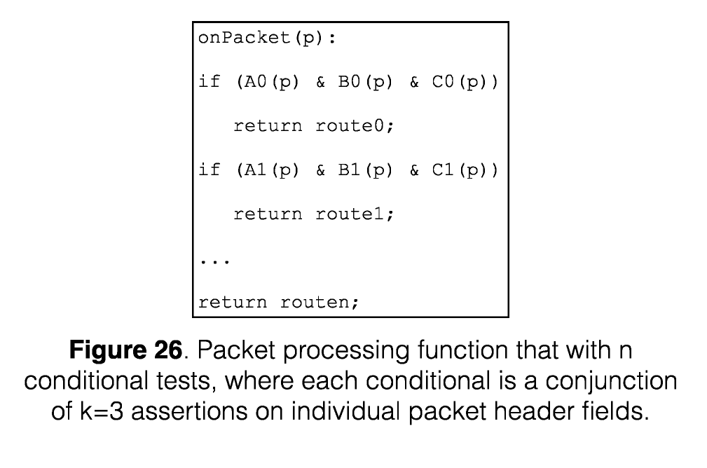

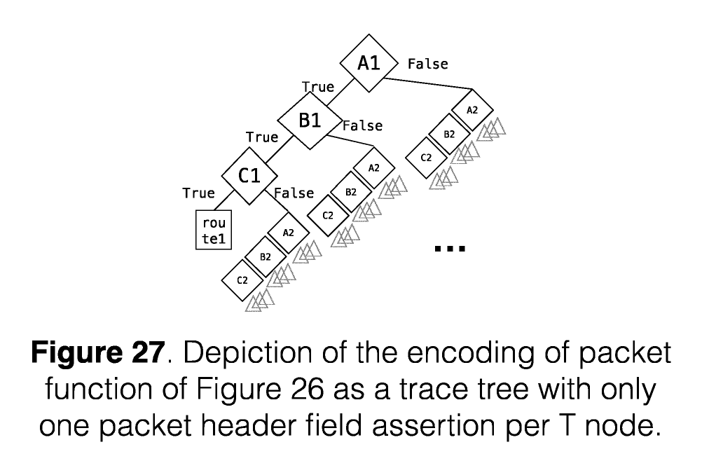

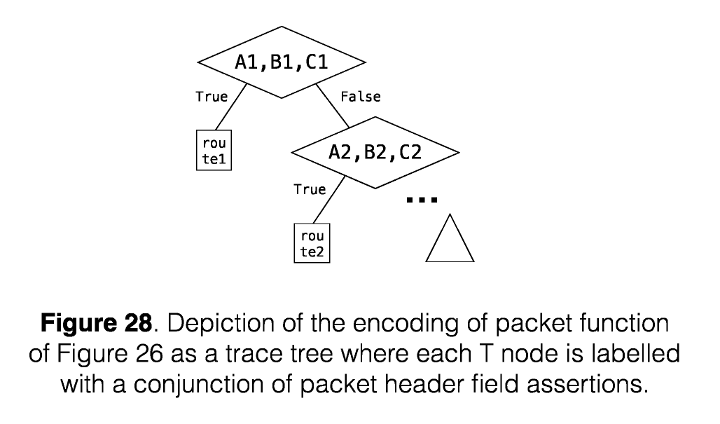

In some embodiments of the invention, the T (assertion) nodes of the trace tree are labeled with a collection of assertions on individual packet header field values, which represents the conjunction (logical AND) of the assertions. This extension of the trace tree data structure allows more compact encoding of certain functions. To illustrate this, consider the packet processing program FIG. 26, which performs n “if” statements where each condition is a conjunction of k=3 assertions on packet fields. FIG. 27 depicts the encoding of this function after expanding the trace tree with evaluation on some packets where the T nodes of the trace tree are labeled with a single packet field assertion. In this case, the number of L nodes will be 1+k+k̂2+ . . . +k̂n. On the other hand, FIG. 28 shows the same function encoded with a trace tree where the T nodes are labeled with a conjunction of assertions from each if statement. In this case, there are exactly n L nodes. The trace tree where each T node can be labeled with a conjunction of field assertions can be extracted from the packet processing program by various methods, such as static analysis of conditional statements, or by enhancing the TAPI with commands such as “AND(a1, . . . , an)” which asserts the conjunction of a collection of TAPI assertions.

The aforementioned extension to the TAPI and trace tree data structure and runtime system to label T nodes with conjunctions of assertions enables the invention to be applied to policies such as network access control using access control policies of sizes that are realistic in modern networks. Such policies may be infeasible to implement without this extension due to exponentially larger function representations required.

In certain embodiments of the invention, the tracing runtime system manages flow tables using a combination of OpenFlow-like network elements and label-switching network elements (e.g. multiprotocol label switching (MPLS)). In these embodiments, the trace tree is used to generate a flow classifier (e.g. OpenFlow forwarding rules) at ingress ports in the network; in other words, the ingress ports are all located at OpenFlow-like network elements that support the prioritized rule tables. The actions in these rules tag the packet with one or more forwarding labels. Other (label-switching) switches in the network then forward packets on the basis of labels, hence avoiding reclassification based on the trace tree. Forwarding labels can be assigned in a naïve manner, such as one distinct label per leaf of the trace tree. Other forwarding label assignment methods may be more efficient. For example, a distinct label may be assigned per distinct forwarding path recorded in the leaves of the trace tree (which may be fewer in number than the total number of leaves). In further refinements, the internal forwarding elements may push and pop forwarding labels (as in MPLS) and more efficient forwarding label assignment may be possible in these cases.

The above-mentioned embodiments of the invention (using label switching in combination with flow classification at edges) enables applications of the trace tree method to hybrid networks, where some network element provide OpenFlow-like forwarding tables while other network elements implement traditional forwarding protocols, such as MPLS.

In certain embodiments of the invention, the packet processing function f may be applied to a “logical topology”, rather than a physical topology of switches and L2 links between switch ports. In these embodiments, the system translates the physical topology to a logical representation presented to the program, and hence changes in the physical topology may (or may not) incur changes to the logical topology presented to the user-defined algorithmic policy. Likewise, the system translates forwarding behaviors expressed on the logical topology back to the physical topology. This technique enables certain embodiments of the invention to apply algorithmic policies to networks in which some network elements are capable of processing packets according to prioritized flow rules, whereas other network elements only provide packet transport. In particular, this can be applied in the following case: all end hosts are attached to access switches (a.k.a. “first hop switches”) that are all OpenFlow-like switches. The access switches are interconnected using an IP-routed network. Then the system permits algorithmic policies where the topology presented to the user consists of a single network element with all end hosts attached. The rule generation is then modified so that the forwarding actions for packets entering an access switch from an end host encapsulate the packets in an IP packet (since the transport network is an IP-routed network). Rules generated for packets arriving at access switches from the transport network first decapsulate the packet and then perform any further actions required by the user policy, including modifying the packet and delivering the packet to the egress ports specified by the algorithmic policy f.

In other embodiments of the invention, the ingress ports are located on OpenFlow-like network elements (called ingress network elements), but the internal network elements are traditional L2 or L3 network elements. In these cases, appropriate (L2 or L3) tunnels are established between various network locations. In this embodiment the runtime generates rule sets at ingress ports that forward packets into the appropriate L2 or L3 tunnel, and replicates packets if a single packet must be forwarded to multiple endpoints. The tunnels create an overlay topology, and the logical topology exposed to the user's algorithmic policy is this overlay topology, rather than the physical topology.

In some embodiments of the invention, the TAPI is extended with a method allowing the packet processing function f to access the ingress switch and port of the packet arrival. Since the ingress port of a packet is not indicated in the packet header itself as it enters the network, and since this information may be required to distinguish the forwarding actions necessary at some non-ingress switch, the runtime system may need a method to determine the ingress port from the packet header. In embodiments of the invention in which frames from any particular source address may only enter the network at a single network location, the host source address can be used to indicate the ingress port of the packet. This method is applicable even when hosts are mobile, since each host is associated with a single network location for a period of time. In other embodiments of the invention (e.g. where the above assumption about source addresses does not apply), the runtime system applies (typically through the action implemented by forwarding rules at network elements) a tag to frames arriving on ingress ports, such that any intermediate network element observing a given packet can uniquely determine the ingress port from the packet header, the applied tag and the local incoming port of the intermediate network element. One embodiment of this technique associates a VLAN identifier to each ingress port location and tags each packet with a VLAN header using the VLAN identifier corresponding to the packet's ingress port. Any forwarding rule at a non-ingress ports matches on the ingress port label previously written into the packet header whenever the rule is required to match a set of packets from a particular ingress port.

Embodiments of the invention that tag incoming packet headers with an identifier that can be used by network elements to distinguish the ingress port of a packet enable several important applications. In one application, one network (the “source network”) is to be monitored by mirroring packets onto a secondary (the “monitoring network”) either by inserting network “taps” on links or by configuring SPAN (Switched Port Analyzer) ports on network elements in the source network. The source network may be tapped in several locations and as a result, copies of the identical frame may arrive into the monitoring network in several locations. As a result, the source MAC address of frames will not uniquely identify the ingress port. A second application enabled by this extension is service chaining, in which the network forwards packets through so-called “middlebox” devices. Middlebox devices may not alter the source address of a frame and hence, the same frame may ingress into the network in multiple locations (e.g. the source location as well as middlebox locations), and hence source address of the frame does not uniquely identify the ingress port of a packet. In both cases, the desired forwarding behavior may require distinguishing the ingress location of a frame, and hence ingress location tagging is required.

In certain embodiments of the invention, each directed network link may have one or more queues associated. Each queue has quality-of service parameters. For example, each queue on a link may be given a weight and packets are scheduled for transmission on the link using a deficit weighted round robin (DWRR) packet scheduling algorithm using the specified queue weights. In these embodiments, the route data structure returned by the packet processing function is permitted to specify for each link included in the route, the queue into which the packet should be placed when traversing the given link. This embodiment permits the packet processing function to specify quality of service attributes of packet flows, and permits the implementation of quality sensitive network services, such as interactive voice or video services.

In certain embodiments of the invention, the L nodes of the trace tree are labeled with the entire forwarding path (and packet modifications) to be applied to the packet. The resulting trace tree is thus a network-wide trace tree. In some embodiments switch-specific rules are compiled by first extracting a switch-specific trace tree from the network-wide trace tree and then applying the compilation algorithms. In other embodiments, the compilation algorithms are extended to operate directly on network-wide trace trees. The extended compilation algorithm may be modified to assign priorities independently for each switch and to generate barrier rules at T nodes only for network locations which require the barrier (the barrier may not be required at certain network locations because the leaf nodes in the “False” subtree of the T node are labeled with paths not using that network location, or because the network location is an internal location.

The trace tree model of algorithmic policies may result in excessively large (in memory) representations of the user policy and correspondingly large representations of compiled flow tables. This arises due to a loss of sharing in translating from algorithmic representation (i.e. as a program) to trace tree representation. In particular, the trace tree may represent a portion of the original program's logic repeatedly. The following example illustrates the problem caused by a loss of sharing.

Consider the following packet processing program for a network with a single network element (hence the return values are simply port numbers on the single network element):

f(p):

If p.mac_type==1, then return g1(p);
ElseIf p.mac_src==1, then return g2(p);
Else return g1(p);

G1(p):

If p.mac_dst == 1: return 1;
ElseIf p.mac_dst == 2; return 2;

ElseIf p.mac_dst == 3: return 3;

...
Else: return 10;

G2(p):

return drop.

The above program returns the path computed by the application “g1(p)” if the packet p has p.mac_type==1. Otherwise the program returns the path computed by the function call “g2(p)” if p.mac_src==1 is true of the packet. Otherwise, the function returns the path computed by “g1(p)”. Using the previously described tracing method to extract a trace tree (after a suitable set of packets is used to perform tracing), the following trace tree may be obtained, which is referred to as “TREE1”, for the program:

Test(mac_type==1,

Read(mac_dst,

| | |
|---|---|
| [ | (1, Leaf(1)), |

(2, Leaf(2)),

...

(10, Leaf(10)) ]

Test(mac_src==1,

Leaf(drop),
Read(mac_dst,

| | |
|---|---|
| [ | (1, Leaf(1)), |

(2, Leaf(2)),
...
(10, Leaf(10)) ]

)

)

For each Test node, the condition being tested is indicated as the first argument, the subtree for the true branch as the second argument and the subtree for the false branch as the third argument.

The tree for g1 will have a single Read branch and then 10 leaves. The tree for g2 will have a single leaf Note that in TREE1, the tree for g1 is repeated. The overall number of leaves in TREE1 is therefore 21. Compilation of TREE1 to flow tables will result in the following table, having 21 rules:

Priority 2: mac_type==1,Mac_dst==1; out port 1.
Priority 2: mac_type==1,Mac_dst==2; out port 2.
...
Priority 2: mac_type==1,Mac_dst==10; out port 10.
Priority 1: mac_src==1, drop.
Priority 0: Mac_dst==1; out port 1.
Priority 0: Mac_dst==2; out port 2.
...
Priority 0: Mac_dst==10; out port 10.

Just as in the trace tree, the flow table repeats the conditions on mac_dst, once at priority level 2, and again at priority 0.

Whereas the original program indicates that identical sub-computations are to be performed for some packets, by explicitly defining the g1 procedure, the program representation as a trace tree loses this information: there is no possibility of safely inferring, solely from examining the given trace tree, that the subtrees at those two locations will remain identical when further traces are added (as a result of augmenting the trace tree with evaluations of some algorithmic policy as described earlier).

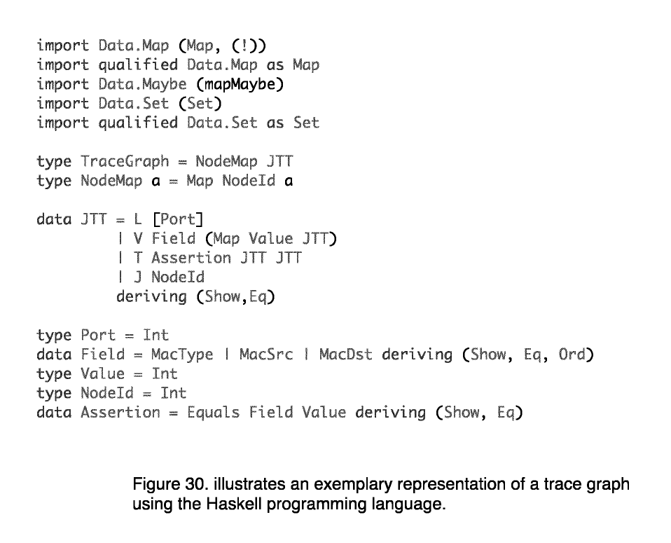

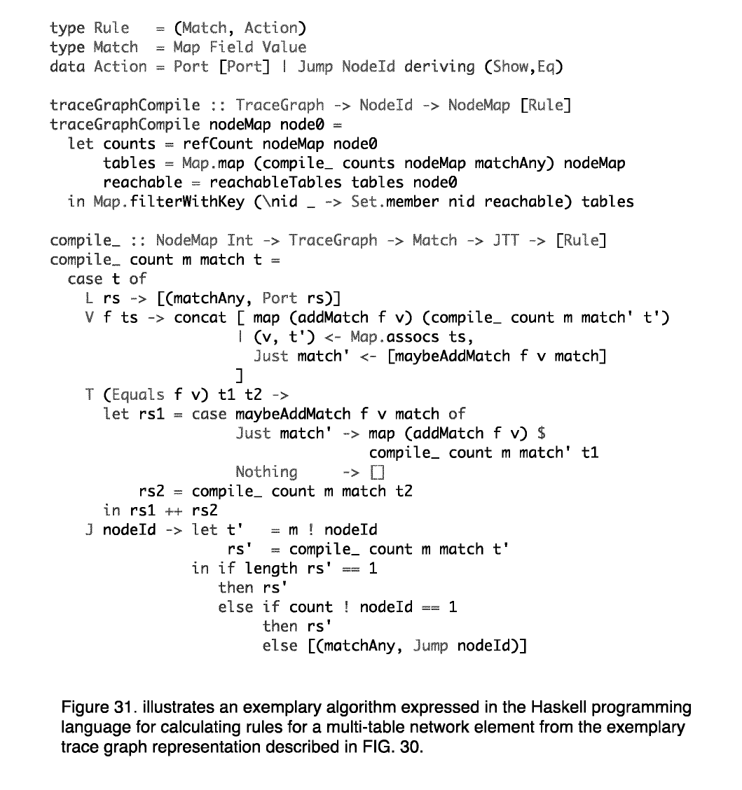

Some embodiments of this invention therefore use an enhanced program representation that permits the system to observe the sharing present in the original packet processing program. In particular, a program is represented as a directed, acyclic trace graph. Various representations of the trace graph are possible. The trace graph concept is illustrated using the following representation, which is a simple variation on the trace tree data structure: a new node is introduced, the J node (J is mnemonic for “jump”), labeled with a node identifier. Trace trees that also may contain J nodes shall be called J-trace trees. A trace graph is then defined to be a finite mapping associating node identifiers with trace graphs. For clarity, an exemplary representation of this trace graph data type is encoded in the Haskell programming language in FIG. 30. To illustrate this representation, the above example trace tree is revisited. The above trace tree could be represented with this trace graph representation as follows, where the node map is represented as a list of pairs, where the first element of the pair is the node identifier for the node and the second element is the node (the function “Map.fromList” creates a finite key-value mapping from a list of pairs where the first element of each pair is the key and the second element of each pair is the value):

Map.fromList [ (0, T(MacType ‘Equals‘ 1) (J 1) (T (MacSrc ‘Equals‘ 1)
(J 2) (J 1)))

, (1, V MacDst (Map.fromList [ (1, L 1), (2, L 2, ..., (10, L 10) ]))
, (2, L drop)
]

This example trace graph is denoted with the name “TraceGraph1”. In the above, the node with identifier 0 jumps to node with identifier 1 if the mac_type field equals 1, and otherwise tests mac_src equal to 1. If this latter test is true, it jumps to node identified by node identifier 2 and otherwise jumps to node 1. TraceGraph1 also provides the trace graphs for node identifiers 1 and 2. Clearly, the trace graph representation requires less memory to store than the original tree representation (TREE1), since it avoids the replication present in TREE1.

It is noted that the trace tree compilation algorithms can easily be adapted to compile from a trace graph, simply by compiling the node referenced by a J node when a J node is reached. Other algorithms, such as SearchTT can be similarly adapted to this trace graph representation.

Some network elements may implement a forwarding process which makes use of multiple forwarding tables. For example, OpenFlow protocols of version 1.1 and later permit a switch to include a pipeline of forwarding tables. In addition, the action in a rule may include a jump instruction that indicates that the forwarding processor should “jump” to another table when executing the rule. Forwarding elements that provide such a multi-table capability shall be called “multi-table network elements”.

In embodiments of the invention employing multi-table network elements, the trace graph representation can be used as input to multi-table rule compilation algorithms which convert a trace graph into a collection of forwarding tables. These algorithms may optimize to reduce the overall number of rules used (summed over all tables), the number of tables used, and other quantities.

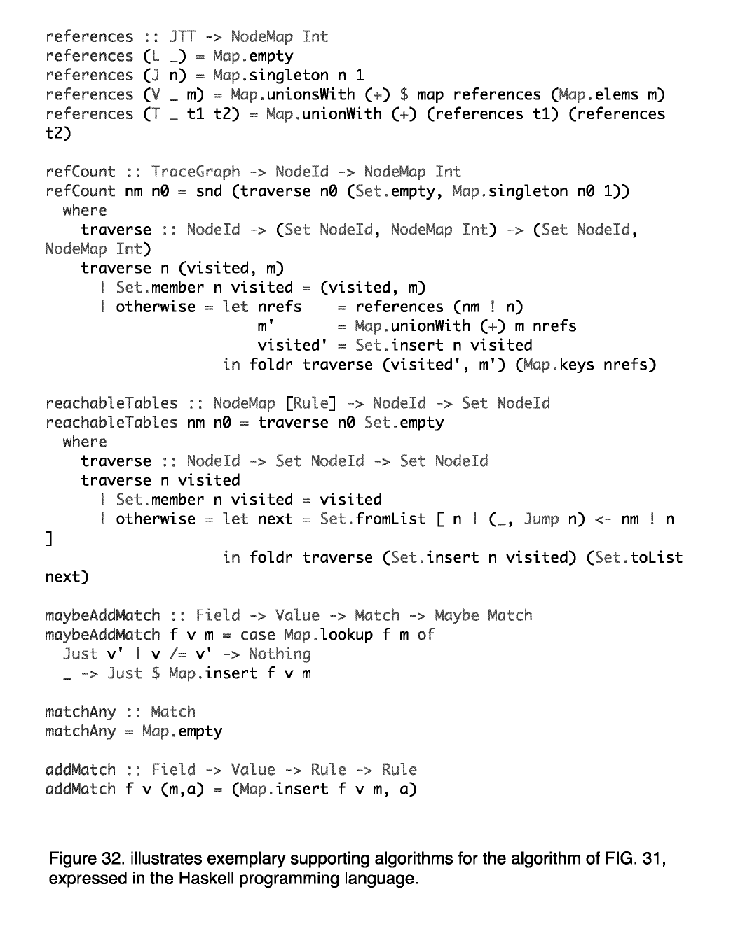

FIGS. 31 (and 32) shows an exemplary multi-table compilation algorithm, named “traceGraphCompile”, operating on a trace graph representation as previously described in FIG. 30. This algorithm minimizes the number of rules used, and secondarily the number of tables used. It accomplishes this by compiling each labeled node of the input trace graph to its own table (i.e. rule set), and eliminating jumps to another table whenever the table being jumped to is jumped to only once, or when the table being jumped to compiles to a rule set consisting of exactly 1 rule. To illustrate the operation of the compilation algorithms in FIG. 31, the output of the compilation applied to TraceGraph1 is demonstrated:

TABLE 0

(fromList [(MacType,1)],Jump 1)
(fromList [(MacSrc,1)],Port [ ])
(fromList [ ],Jump 1)

TABLE 1

(fromList [(MacDst, 1)], Port [1])
(fromList [(MacDst, 2)], Port [2])
(fromList [(MacDst, 3)], Port [3])
(fromList [(MacDst, 4)], Port [4])
(fromList [(MacDst, 5)], Port [5])
(fromList [(MacDst, 6)], Port [6])
(fromList [(MacDst, 7)], Port [7])
(fromList [(MacDst, 8)], Port [8])
(fromList [(MacDst, 9)], Port [9])
(fromList [(MacDst, 10)], Port [10])

It should be noted that this result uses only 13 rules to implement the same packet processing function as the earlier forwarding table, which used 21 rules. Further embodiments may make refinements to this basic compilation algorithm, for example to take the matching context at the location of a J node into account when choosing whether to inline or jump a particular J node.

In some embodiments of the invention, the algorithmic policy f is processed with a static analyzer or compiler in order to translate the program into a form such that a modified tracing runtime can extract modified execution traces which can be used to construct the trace graph of an input program, in the sense that the trace graph resulting from tracing execution of the input policy on input packets correctly approximates the original algorithmic policy. In particular, this can be accomplished by translating the input program into a number of sub-functions f1, . . . , fn, each of which takes a packet and some other arguments, such that return statements in each of these functions are either a Route (i.e. as previously defined) or is a pair (i, args), where i is a sub-function in the range 1 . . . n and args is a list of arguments required to invoke fi. Furthermore, the binary relation on the set {1 . . . n} given by (i,j) such that fi may return the pair (j, args) in at least one execution for some argument list args, must form a partially ordered set (this is in order to create a valid pipeline). Once the program is translated into this form, the tracing runtime is modified as follows. The tracing runtime maintains a J-trace tree for the pair (1, [ ]) and for each pair (i, args) which is encountered as a return value of an invocation of one of the functions f1 . . . fn during tracing. The J-trace tree for function i and arguments args is denoted JTree(i, args). On receiving a packet, i is initialized to 1, args is initialized to [ ] (the empty list) and the following is performed: the tracing runtime executes fi(p, args) on the given input packet. If the return value is a Route, tracing is terminated, and the J-trace tree with node identifier i is augmented with the given trace with a leaf value containing the returned route. If the return value is a pair (j, args2), then the trace is recorded in the J-trace tree for node identified by i with a J node labeled by the node identifier for Tree(j, args2), and this process continues with i set to j and args set to args2.

A static analysis or compilation is used to translate a program written in the user-level language for expressing algorithmic policies into the form required for the trace graph tracing runtime. In the above-mentioned example policy, the only modification required is to transform f into the following form:

f(p):

If p.mac_type==1, then return (1,[ ]);
ElseIf p.mac_src==1, then return (2, [ ]);
Else return (1,[ ]);

Certain embodiments may use static transformations, to translate the program into the desired form. The following example illustrates the possible transformation that may be required. Consider an example algorithmic policy which performs two access control checks before performing routing:

f(p):

if permitted1(p) && permitted2(p), then return

bestRoute(p);

else return drop;

Suppose that in addition, each of permitted1, permitted2 and bestRoute should be considered for compilation into separate tables. Then the program should be transformed to the following form:

f1(p):

if permitted1(p), return (2,[ ])
else return drop;

f2(p):

if permitted2(p), then return (3,[ ])
else return drop;

f3(p):

return bestRoute(p);

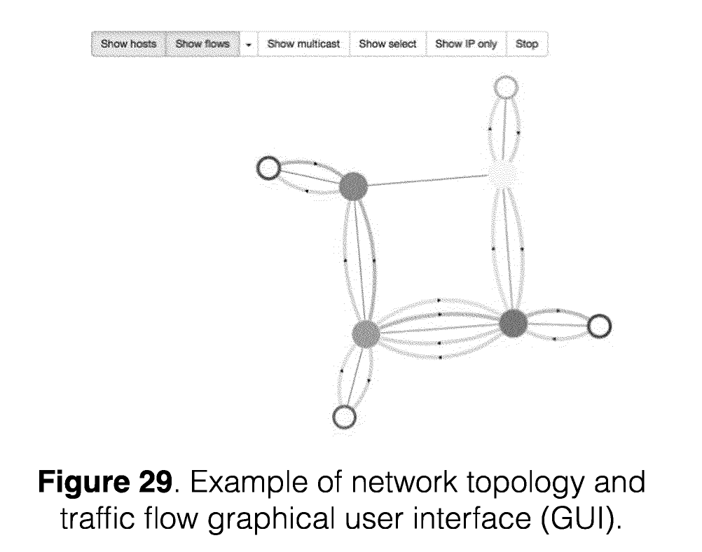

In some embodiments, the system is enhanced with a Graphical User Interface (GUI) which displays system information in graphic form. Some embodiments include a visual representation of the topology, such as that depicted in FIG. 29. The representation depicts network elements (solid circles), hosts (hollow circles) and links between network elements and connections between hosts and network elements. This network topology GUI can be interactive, allowing the user to organize the placement of nodes and to select which elements to display. The topology GUI may also depict traffic flows, as the curved thick lines do in FIG. 29. Flow line thickness may be used to indicate the intensity of traffic for this network traffic flow. Arrows in the flow lines may be used to indicate the direction of packet flow. Various GUI elements (such as buttons) allow the user to select which flows to display. Selections allow the user to show only flows that are active in some specified time period, inactive flows, flows for specific classes of traffic such as IP packets, flows forwarding to multiple or single destination hosts. The flow GUI may allow the user to specify which flows to show by clicking on network elements to indicate that the GUI should show all flows traversing that particular element.

Some embodiments of the invention may execute the methods locally on a network forwarding element, as part of the control process resident on the network element. In these embodiments, a distributed protocol may be used in order to ensure that the dynamic state of the algorithmic policy is distributed to all network elements. Various distributed protocols may be used to ensure varying levels of consistency among the state seen by each network element control process.

Some embodiments of the invention will incorporate an algorithm which removes forwarding rules from network elements when network elements reach their capacity for forwarding rules, and new rules are required to handle some further network flows. In some systems, the following Least Frequently Used (LFU) policy with aging is used. In this policy, flow statistics for all flows are maintained and an algorithm, such as exponential weighted moving average (EWMA) is used to calculate instantaneous flow rate for each flow. When a new flow is to be installed in network elements where some of the elements S1, . . . , Sk have flow tables that have reached capacity, the following steps are taken. A collection of flows F1, . . . Fm is determined such that the sum of the flow rates for F1, . . . , Fm is the lowest for all subsets of flows (among flows with installed rules) such that removing F1, . . . , Fm frees up enough flow table capacity in switches S1, . . . Sk to allow the new flow to be installed. In some embodiments, the new flow may be associated with an estimated flow rate, which is used to determine which flows to evict; in these embodiments, the new flow may itself have the least expected flow rate, and hence may not be installed, resulting in no flows being evicted.

The following provides a non-exhaustive list of specific network elements that may be used: Open VSwitch (OVS), Linc software switch, CPQD soft switch, Hewlett-Packard (HP) FlexFabric 12900, HP FlexFabric 12500, HP FlexFabric 11900, HP 8200 zl, HP 5930, HP 5920, HP 5900, HP 5400 zl, HP 3800, HP 3500, HP 2920, NEC PF 5240, NEC PF 5248, NEC PF 5820, NEC PF 1000, Pluribus E68-M, Pluribus F64 series, NoviFlow NoviSwitches, Pica8 switches, Dell SDN switches, IBM OpenFlow switches, Brocade OpenFlow switches.

At act 2130 of method 2100, the derived forwarding configuration(s) may be applied to the appropriate data forwarding element(s) in the network, such as by sending a derived forwarding rule to its associated data forwarding element(s) for inclusion in the data forwarding element's set of forwarding rules. In some embodiments, priorities may be assigned to the derived forwarding rules or other forwarding configurations, such as by observing the order in which the controller queries different characteristics of data packets in applying the user-defined packet-processing policy, and assigning priorities based on that order (e.g., traversing a trace tree from root to leaf nodes, as discussed above, thereby following the order in which packet attributes are queried by the controller). In some embodiments, as discussed above, further optimization techniques may be applied, such as removing unnecessary forwarding configurations (e.g., rules), reducing the number of priority levels used, and/or invalidating stale forwarding configurations when a change of network state is identified from the network attributes queried.

In some embodiments, derived forwarding configurations may be applied to the corresponding data forwarding elements immediately as they are derived. However, this is not required, and derived forwarding configurations may be “pushed” to network elements at any suitable time and/or in response to any suitable triggering events, including as batch updates at any suitable time interval(s). In some embodiments, updates to network element forwarding configurations can be triggered by changes in system state (e.g. environment information such as network attributes) that invalidate previously cached forwarding configurations, such as forwarding rules. For example, if a switch port that was previously operational becomes non-operational (for example due to the removal of a network link, a network link failure, or an administrative change to the switch), any rules that forward packets to the given port may become invalid. Some embodiments may then immediately remove those rules, as well as removing any corresponding executions recorded in the trace tree(s) of the tracing runtime system. In some embodiments, other changes to network element forwarding configurations may be made in response to commands issued by the user-defined policy, such as via the user-defined state component described above.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation comprises at least one processor-readable storage medium (i.e., at least one tangible, non-transitory processor-readable medium, e.g., a computer memory (e.g., hard drive, flash memory, processor working memory, etc.), a floppy disk, an optical disc, a magnetic tape, or other tangible, non-transitory computer-readable medium) encoded with a computer program (i.e., a plurality of instructions), which, when executed on one or more processors, performs at least the above-discussed functions. The processor-readable storage medium can be transportable such that the program stored thereon can be loaded onto any computer resource to implement functionality discussed herein. In addition, it should be appreciated that the reference to a computer program which, when executed, performs above-discussed functions, is not limited to an application program running on a host computer. Rather, the term “computer program” is used herein in a generic sense to reference any type of computer code (e.g., software or microcode) that can be employed to program one or more processors to implement above-discussed functionality.

The phraseology and terminology used herein is for the purpose of description and should not be regarded as limiting. The use of “including,” “comprising,” “having,” “containing,” “involving,” and variations thereof, is meant to encompass the items listed thereafter and additional items. The description herein of any aspect or embodiment of the invention using terms such as reference to an element or elements is intended to provide support for a similar aspect or embodiment of the invention that “consists of,” “consists essentially of” or “substantially comprises” that particular element or elements, unless otherwise stated or clearly contradicted by context (e. g., a composition described herein as comprising a particular element should be understood as also describing a composition consisting of that element, unless otherwise stated or clearly contradicted by context). Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described several embodiments of the invention, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

1. In a data communications network comprising a plurality of data forwarding elements each having a set of forwarding rules and being configured to forward data packets according to the set of forwarding rules, the data communications network further comprising at least one controller including at least one processor configured to update forwarding rules in at least some of the plurality of data forwarding elements, a method comprising:
accessing, at the at least one controller, an algorithmic policy defined by a user comprising one or more programs written in a general-purpose programming language other than a language of data forwarding element forwarding rules, which algorithmic policy in particular defines a packet-processing function specifying how data packets are to be processed through the data communications network;
applying the packet-processing function at the at least one controller to process a first data packet through the data communications network, whereby the first data packet has been delivered to the controller by a data forwarding element that did not contain a set of forwarding configurations capable of addressing the data packet;
recording one or more characteristics of the first data packet queried by the at least one controller in applying the packet-processing function to process the first data packet, and a manner in which the first data packet is processed by the packet-processing function;
defining forwarding rules specifying that data packets having the one or more queried characteristics are to be processed in the manner in which the first data packet is processed; and
applying the derived forwarding rules to the at least one data forwarding element, wherein
1. the user-defined algorithmic policy declares state components including variables of any type, sets containing elements of any type, and finite key-value maps with arbitrary key and value types, and the packet processing function accesses said state components when processing a packet through read or write operations,
2. the dependency of an algorithmic policy execution on declared state components accessed during the execution is recorded in a state dependency table, and
3. when a state component is changed the state dependency table is used to determine the packet processing function executions which may no longer be valid, and the derived forwarding rules for invalidated executions are removed from the at least one data forwarding element and updates of other network element forwarding rules are made if needed to ensure correctness in the absence of the removed rules.

2. The method of claim 1, wherein state component update commands issued by external agents according to specific communication protocol, are accepted and executed by the at least one controller to accomplish changes to declared state components.

3. (canceled)

4. (canceled)

5. The method of claim 1, wherein (1) the packet processing function is permitted to update the values of declared state components during execution and (2) the method of defining forwarding rules after execution of the packet processing function on a packet is modified to not install any forwarding rules after an execution which would match a packet that would lead to further changes to state components, and (3) the method of updating forwarding rules is modified so that after a change to a collection of state components, any forwarding rules which were previously applied to network elements and which would match at least one packet that would cause a change to one or more state components if the packet processing function were executed upon it with the changed state components, are removed from network elements in which they are applied and any remaining forwarding rules are repaired to ensure correctness in the absence of the removed rules.

6. The method of claim 5, wherein a read-write interference detection algorithm is used by the at least one controller to determine whether forwarding rules developed from tracing the execution of a packet processing function on a packet match only packets that do not cause further state changes.

7. In a data communications network comprising a plurality of data forwarding elements each having a set of forwarding rules and being configured to forward data packets according to the set of forwarding rules, the data communications network further comprising at least one controller including at least one processor configured to update forwarding rules in at least some of the plurality of data forwarding elements, a method comprising:
accessing, at the at least one controller, an algorithmic policy defined by a user in a general-purpose programming language other than a language of data forwarding element forwarding rules, which algorithmic policy defines a packet-processing function specifying how data packets are to be processed through the data communications network;
applying the packet-processing function at the at least one controller to process a first data packet through the data communications network, whereby the first data packet has been delivered to the controller by a data forwarding element that did not contain a set of forwarding configurations capable of addressing the data packet;
recording one or more characteristics of the first data packet queried by the at least one controller in applying the packet-processing function to process the first data packet, and a manner in which the first data packet is processed by the packet-processing function;
defining forwarding rules specifying that data packets having the one or more queried characteristics are to be processed in the manner in which the first data packet is processed and
applying the derived forwarding rules to the at least one data forwarding element, used to implement any of the following network services:
a. Ethernet (L2) network services,
b. IP routing services,
c. Firewall services,
d. Multi-tenant cloud services, including virtual address spaces,
e. Network Address Translation (NAT) services,
f. Server load balancing services,
g. ARP proxy,
h. DHCP services,
i. DNS services,
j. Traffic monitoring services (forwarding traffic of desired classes to one or more monitoring devices connected to the network),
k. Traffic statistics collection,
l. Service chaining system where packets are delivered through a chain of services, according to user-specified per-traffic class service chain configuration, where services may be realized as traditional network appliances or as virtualized as virtual machines running on standard computing systems,
m. Traffic engineering over wide-area network (WAN) connections, or
n. Quality of service forwarding to support voice and video network applications.

8. The method of claim 1, wherein (1) when the one or more controller executes the packet processing function on a packet and defines and applies forwarding rules to network elements, the controller stores said packet in memory and (2) after a change to state components is made at some later time, and the dependency table is used to determine invalidated executions, the packet processing function is executed on the stored packet for each invalidated execution in such a way that (a) any executions that would perform a change to state components are abandoned and the state components are not updated, and (b) executions that do not perform state changes are recorded and used to define new forwarding rules.

9. The method of claim 1, wherein (a) the at least one controller accesses a collection of functions defined by a user in a general-purpose programming language where each function defines a procedure to perform in response to various network events, such as network topology changes, and (b) the at least one controller recognizes, through interaction with network elements, when network events occur and executes the appropriate user-defined function for the event.

10. (canceled)

11. The method of claim 1, wherein the algorithmic policy permits
1. definition of new traffic counters for either one or both packet and byte counts,
2. the packet processing function to increment said counters,
3. the packet processing function and any other procedures defined in the algorithmic policy, including functions associated with network events or timer expirations, to read the values of said counters,
4. the registration of computations to be performed when a counter is updated, and
5. external processes to query said counters through a defined communication protocol, and
wherein the distributed traffic flow counter collection method is utilized by the at least one controller to monitor flow rule counters in network elements at the ingress point of traffic flows and to correlate flow rule counter measurements with traffic counters declared in the algorithmic policy.

12. (canceled)

13. The method of claim 1, wherein (a) programs comprising the algorithmic policy are permitted to construct, either during packet processing function or other procedures, a frame and to request that it be sent to any number of switch ports, (b) the at least one controller delivers the frames requested to be sent, and (c) the defining of forwarding rules after packet processing function execution is modified so that if an execution causes a frame to be sent, then no forwarding rules are defined or applied to any network elements for said execution.

14. The method of claim 1, wherein (a) the packet processing function is permitted to access attributes of packets which are not accessible in forwarding rules applicable to network elements, and (b) the defining of forwarding rules after a packet processing execution is modified so that no forwarding rules are derived for executions which accessed attributes which were not accessible in forwarding rules applicable in network elements.

15. The method of claim 1, wherein (a) the packet processing function is permitted to modify the input packet and (b) the defining of forwarding rules after a packet processing function execution is modified so that the defined forwarding rules collectively perform the same modifications as performed in the packet function execution.

16. (canceled)

17. The method of claim 15, wherein the method of defining forwarding rules after a packet processing function execution is modified so that the defined forwarding rules perform any required packet modifications just before delivering a copy of the packet on an egress port and no packet modifications are performed on any copy of the packet forwarded to another network element.

18. The method of claim 1, wherein (a) one or more packet queues are associated with each port, where the packet queues are used to implement algorithms for scheduling packets onto the associated port, (b) the route returned by the packet processing function is permitted to specify a queue for every link in the route, where the queue must be associated with the port on the side of the link from which the packet is to be sent, and (c) forwarding rules defined for an execution of the packet processing function are defined so that rule actions enqueue packets onto the queue specified, if any, by the route returned from the execution.

19. (canceled)

20. (canceled)

21. The method of claim 1, wherein forwarding rules are defined by using a trace tree developed from tracing packet processing function executions, wherein (a) the packet processing function is permitted to evaluate conjunctions of packet field conditions, (b) T nodes of trace trees are labeled with a collection of field assertions, and (c) enhanced trace tree compilation is used to define forwarding rules from trace trees with T nodes labeled by collections of field assertions.

22. (canceled)

23. The method of claim 1, wherein (a) the packet processing function is supplied with a logical network topology, and (b) after obtaining the returned route through the logical topology from an execution of the packet processing function on a packet, the returned route is transformed into a route on the physical network topology.

24. (canceled)

25. The method of claim 1, wherein the packet processing function is permitted to access the ingress port of a packet and the defining of forwarding rules after packet processing execution is modified as follows: (a) a unique identifier is associated with each possible ingress port, and (b) the forwarding rules defined for the packet's ingress port write the unique identifier into the packet header, and (c) forwarding rules defined for packets arriving at a non-ingress port match on the unique ingress port identifier in the packet header whenever the rule is intended to apply to a subset of the packets originating at a particular ingress port.

26. The method of claim 1, wherein (a) packet processing function execution is modified to develop a trace graph representation of the packet processing function, and (b) forwarding rules are compiled from trace graph representation.

27. (canceled)

28. (canceled)

29. The method of claim 26, wherein a static analysis algorithm is applied to the packet processing function prior to execution in order to transform it into a form which will develop a trace graph representation during tracing of the packet processing function at runtime.

30-33. (canceled)

34. The method of claim 8, wherein the cancelUpdates method is used to consolidate several sets of forwarding rule edits to determine a single, overall update to apply to network elements.

35. The method of claim 26, wherein the trace graph representation is used to compile forwarding rules for multiple flow tables for network elements supporting multiple flow tables.
